(19) United States
(12) Patent Application Publication
(10) Pub. No.: US 2007/0094268 A1
(43) Pub. Date: Apr. 26, 2007

(54) Broadband centralized transportation communication vehicle for extracting transportation topics of information and monitoring terrorist data

(76) Inventor: Joseph A. Tabe, (US)

Correspondence Address: Joseph A. Tabe;Taintech Corporation, 11700 Old Columbia Pike, Suite 717, Silver Spring,, MD, 20904, US

(21) Appl. No.: 11/254,973

(22) Filed: Oct. 21, 2005

(51) Int. Cl. G06F 17/30

(52) U.S. Cl. 707/10

(57) ABSTRACT

A centralized Transportation communication vehicle for extracting transportation topics of information from a database such as the web, such that the web is made searchable for occurrences of topics of transportation information. The occurrences of topics of transportation information that were found in the database are analyzed to identify a pattern in which the topics were stored or extracted, and enabling the web and the topics to form a centralized transportation communication engine that enables communication with different systems and responsive to all different platforms, enabling the different platforms to talk to one another through one centralized system that integrates with all government transportation agencies, all police stations, all fire department agencies, homeland security agencies, and all local government agencies seamlessly in real time. The centralized transportation engine forming a broadband for a centralized transportation communication vehicle having the capabilities to integrate seamlessly with all existing transportation industries, commercial transportation companies, homeland security department, all fleet STEMS, car rental companies and all garages in the nation and around the world through their local existing systems and enable these systems to talk to each other and communicate better in real time interaction, real responsive, real resourceful, and real responsible to transportation system analysis, preventive maintenance scheduling and reprogramming, monitoring of at least a terrorist desiring transportation topics of information, and enabling a centralized database interaction with existing transportation companies.

### FIELD OF THE INVENTION

The present invention relates to a centralized transportation communication vehicle for enabling transportation industries, garages, transportation maintenance fleet STEMS, government agencies, police department, fire department, Homeland security department to talk to each other seamlessly in real time through a centralized system and for extracting transportation topics of information from a centralized transportation database having information relating to different makes and models of transport vehicles and enabling communication with different systems and responsive to different platforms. More specifically, the invention relates to a centralized transportation searchable vehicle for enabling searching the web for topics of information relating specifically to any make and model of transportation equipment in order to identify preventive maintenance and repair patterns of that particular equipment in which the topics were stored so that additional topics can be extracted from the database to aid file sharing within various transportation companies and mining terrorist data within a centralized transportation database.

The system integrates seamlessly with all existing transportation industries, including car rental companies and all garages in the nation and around the world through their local existing systems and enabling these systems to talk to each other and communicate better in real time interaction, real responsive, real resourceful and real responsible to transportation system analysis, preventive maintenance scheduling and reprogramming, and monitoring of a terrorist person's activities through at least a name search.

This invention further relates to management and sharing of transportation topics of information through networks of computational devices, and more particularly to generating request of transportation information, providing at least one topic of information as an example of information associated with at least a terrorist name in a local existing system desiring a rental car, and retrieving responses to transportation topics of information such that enhancement of identification of relevant transportation topics of information is made accessible using such a network for repeating the searching and analyzing and extracting data for additional topics of information that is desired for tracking the last rental company and/or transportation information by the said named terrorist.

The centralized transportation vehicle is a STEMS International search engine tool to facilitate locating the desired transportation topics of information in a network such as the STEMS WEB-SITE. An end user usually would have to access the STEMS web site that will hosts the centralized transportation vehicle or STEMS International search engine for routing transportation topics of information and submits one or more search queries related to the information type. Generally, this STEMS International search engine is a computer program that when queried for transportation topics of information, retrieves either related information or pointers to the location of related information, or both, by evaluating the STEMS server database.

STEMS is a “Standard Transportation Excellent Maintenance Solution” for all transportation vehicles with links to transportation agencies, Police department, Homeland security department and the like. However, no such method ever existed that is centralized and opened for every transportation corporation and that will enable department of transportation “DOT” do file history of a particular vehicle or such vehicle instantly without having to go to the actual site or business operation of the company operating such vehicle to search for the hard copy files of the particular vehicle in question. Moreover, no such method ever existed that will enable drivers name search and critical solutions to a malfunctioned vehicle component without the insertion of a diagnostic tool but rather enabling solution for the failed component when such failed or malfunction component is precisely described in a system such as the Internet. Additionally, no such method ever existed that will schedule a preventive maintenance inspection for any particular vehicle when such vehicle has attained a certain mileage indicative of a respective mileage or fuel consumption requirement to enable a scheduled maintenance inspection. However, most if not all inventions arise from a combination of old elements in the art to address a particular need or unsolved problem.

### BACKGROUND OF THE INVENTION

The present invention is a centralized transportation vehicle having a STEMS International search engine system that includes an entity extractor, a categorizer, and a query generator for managing and sharing transportation activities such that when a topic on transportation information is queried, responses are retrieved to enrich transportation preventive maintenance scheduling, generating solution to queried transportation component failure, extracting names of terrorist desiring a rental car, and analyzing failed transportation component through a centralized database. The entity extractor identifies a set of entities as described in the transportation topic of information through selected transportation files, forms, or document content for enabling searching the information related thereto using an information retrieval system. The categorizer defines an organized classification of the transportation files, forms, or document content with each class in the organization of component content having associated therewith a classification label. The classification label corresponds to a category of topics of transportation information in the information retrieval system. The categorizer assigns the selected transportation files, forms, or document content a classification label from the organized classification of transportation component content. A query generator automatically formulates a query that restricts a search for transportation topics of information at the information retrieval system for the particular information concerning the set of entities to the category of transportation topics of information in the information retrieval system identified by the assigned classification label to enable speedy responses to transportation information from the centralized transportation vehicle.

The centralized transportation vehicle is designed to enable enhancement of continued proliferation of powerful and suitable transportation operation, allowing computational devices to talk to each other through the use of networks connecting these devices. Computational devices include computers and other portable devices such as wireless telephones, mega telecommunication, personal digital assistants, and automobile-based computers. Such portable computational devices are pervasive devices. The networks connecting computational devices for the instant invention are wired networks which are formed using land lines such as copper wire or fiber optic cable, and wireless networks which employ earth and/or satellite-based wireless transmission links and a combination of wired and wireless network portions. These networks are organized using a client/server architecture in which server computational devices manage transportation operational resources such as preventive maintenance files, solutions to failed transportation component, fuel consumption per vehicle in a fleet, computational transportation devices processing power which could be requested by client computational devices such as users of the network. That is, other computational devices not operated directly by an end user such as at least proxy servers, which act on behalf of other machines, could represent either clients or servers.

The vehicle is provided with a system that generates a query for end users using an entity extractor, a categorizer, a query generator with a short run aspect vector. The entity extractor identifies a set of entities in selected file content for searching information related transportation operation and maintenance through an information retrieval system. The categorizer establishes an organized classification of individual company file content per equipment with each class in the organization of the content having associated classification labels that correspond to a category of information in the information retrieval system, and the file content containing equipment components per make and models relevant for retrieval of solutions to specific queries. The categorizer assigns the selected file content a classification label from the organized classification of content in relation to responding to the queried information in real time. The query generator gathers each query that restricts a search at the information retrieval system to the category of information in the information retrieval system identified by the assigned classification of the individual companies, while allowing the query generator having the short length aspect vector generator to generate terms for further refining the query using context information surrounding the set of entities in the selected file content so that files and transportation files, forms, or document s are searchable through the centralized transportation vehicle and integrating seamlessly with all existing transportation industries, commercial transportation companies, all fleet STEMS, and all garages in the nation and around the world through their local existing systems and enabling these systems to talk to each other and communicate better in real time interaction, real responsive, real resourceful, and real responsible to transportation system analysis, preventive maintenance scheduling and reprogramming, and enable the centralized database interaction with these existing companies through their local computers.

At this time, a very widely used network for the centralized transportation vehicle which will be used to connect transportation topics of information is the Internet, a global network of computational devices which communicate using a set of protocols called TCP/IP “transmission control protocol/Internet protocol”. A particularly popular aspect of the Internet is the World Wide Web (WWW, or “web”), which is a collection of interlinked transportation files, forms, or document s formatted in hypertext markup language (HTML) to be used for separating transportation topics of information. These transportation files, forms, or document s, or “web pages”, may incorporate text, graphics, audio, and/or video content, and may include suitable links to one another, often called “hyperlinks” or simply “links”. Transportation files, forms, or document s or files are requested by client computers through an application program called a web browser. The files are requested from server computers, or “web servers”. The transmission of the files over the web uses an additional Internet protocol called hypertext transfer protocol (HTTP).

A significant feature of the Internet is that it is substantially free of central organization. A server hosting web page for the centralized transportation system is connected to the Internet and the transportation topics of information are routed by the transportation vehicle or STEMS International search engine to the server for retrieval of information specific to the queried transportation topic information from the server database. The centralized transportation system would enable decentralization of transportation topics of information and also allows extremely wide access and an ever-increasing variety and availability of information relating to various transportation vehicles, identifying and locating specific pieces of information on a specific topic such as vehicle component failure on a particular brand of vehicle that can be extremely difficult to diagnose. Generally, a database system is developed and a STEMS International search engines and directories would route all the transportation topics of information to the server containing the database developed to aid users in finding specific types of information unique to transportation vehicles. The database system would typically contain an entry for each web page and other transportation associated files and transportation files, forms, or document to enable the database to be searchable relatively quickly without any intervention or the need to retrieve actual web pages in order to perform a search.

An entry for retrieval of information from the database may include a network address of the end user page with one or more keywords associated with the page content and a brief summary of the topic of information to be searched. The STEMS International search engine, which is often used to describe any such database system, distinguishes itself from directory in that, it routes all transportation topics of information from the internet to the database server, collecting transportation topics of information automatically using programs such as spiders, robots and/or crawlers, which will visit the centralized transportation web page and collect the needed data by downloading files in relation to the queried topics of information and also process the file. At this time, available STEMS International search engines include engines by AltaVista, Google, Yahoo, and Excite. Their search engines are not toned for routing transportation topics of information and have no way of directing or enabling scheduling of preventive maintenance based on vehicle mileage or fuel consumption. In addition, a directory may be used with the STEMS International search engine to describe the end user or a database for which entry information is submitted.

The centralized transportation vehicle is a process-driven transportation management system for managing data relating to transportation codes and modules. The transportation management system includes a server repository that stores vehicle information, wherein one of the vehicles is referred to as planes having components each describing a respective mechanical failure codes.

In one instance of the invention, STEMS will link computers in the transportation industries and transportation technologies together by directing end users to transportation topics of information through the centralized transportation vehicle, making it easier for employees of these industries to share files and data resources through a centralized transportation network system. The shared network will enable communication with every transportation industries, every garage, and all commercial transportation companies seamlessly through a resourceful time sharing via shared Internet access. The centralized transportation vehicle includes a centralized transportation system. The centralized transportation system includes server-based network to enable reliable solutions to local and distance transportation industries. The server network will connect industrial employees through a local network to topics of information resourceful to their business maintenance program and preventive maintenance and step by step repair procedures for a failed vehicle component. The server network is capable of instantly accessing more than one hundred million end users per second to its database, which is accessed through desktop computers, notebooks, wireless devices, and megatel devices from any state in the U.S. and any part of the world.

The Web context will be based on queries, such that, when a user submits a query containing transportation topics of information, the STEMS International search engine will respond with a list of links pointing to information resource for the STEMS web page hosting derived from matching entries on transportation topics of information in the STEMS International search engine's database. As used herein, the term “link” is generally any representation or symbol representing at least an address that points to the location of an information resource, such as a web page. Typically, a link on the Web is a pointer found in one file which references another file. The link on the Web commonly refers to a Uniform Resource Locator (URL), the global address of transportation files, forms, or document s and other resources common on the Web. The centralized transportation network system uses direct attached storage to the server hard drive having a network attached storage to consolidate files stored. The server software periodically dumps files into a backup server for future corporate use.

The centralized transportation network system uses a server adaptor to maximize productivity and end user longevity by allowing end users to always stay connected through the STEMS International search engine. Thus, the entire network system will periodically need maintenance and the URL may be modified at random times by their web masters. When a webmaster changes the content of a web page, including adding or removing content or deleting the page altogether, a STEMS International search engine database does not immediately reflect these changes. A typical search will produce a single link that either point to STEMS web site OR ITS MODIFIED WEB SITE. Accordingly, when a user clicks on the URL and an error results comes on, if the user is unable to access the envisioned content, the STEMS International search engine will strive to keep track of the Web by continuously finding, indexing, and cataloging web pages. The server adaptor software will automatically re-routes the traffic signals when any of the server port experiences a failure or is disconnected. Files are always monitored and allow access to multiple server files containing client data to enable prevention of any loss of information when the hardware experiences a failure. The multiple file storage system is also centralized for maximum protection. The centralized transportation network system uses a switch to connect client system and servers together to create a client server network within the system. The backup storage software enables backup scheduling such as tape backup and server file storage backup in weekly, daily, or monthly intervals. The backup allows the centralized transportation system access to remotely recover any lost file. The process enables the system to eliminate single point failure by advancing the technology to keep single components on hand for emergency use. However, indexing as explained here means the storing of links pointing to information resources including some or all of the data associated with the information resource.

The transportation management system includes a set of tools for performing innovative renovation of transportation component and analytical breakdown of possible solutions. This transformation provides a process-based interface to transportation topics of information with end users. This interface is developed using Protocols, Processes, and Plans. Protocols are the constructs that each stores a script for invoking a respective scripted tool to execute a particular function. The Protocols is a software module that is provided as input parameters for retrieving relevant transportation information or generating an output parameter of the function invocation specified as variables supplied at execution time. Although most STEMS International search engines utilize computer applications called spiders or robots to index the different elements of web sites on the Internet and gather content information for their STEMS International search engine's databases, none of these STEMS International search engines addresses content of the transportation topics of information. Essentially, a STEMS International search engine robot indexes a significant number of all the information resources in the Internet. Ordinarily, the robot will update the links in the transportation STEMS International search engine's database in a queried dependency manner so that transportation topics of information are better shared to:
Improve productivity
Improve homeland security and data mining
Improve environmental safety
Cut maintenance cost
Gain maintenance and repair flexibility
Share resources to gain optimal output in minimal time
Increase collaboration through file sharing
Improve corporate data security
Detect intrusion through multiple firewall configuration
Enable corporate privacy control and prevents confidential information
Enable anti spam filtration of unwanted queries
Utilize bus to offer point to point lanes to the database
Deliver peak performance to meet demands for industrial multitasking
Enables continuous background virus check and scanning at firewall
Enable multimedia application with intensified multitasking between industries
Connecting more employees with maximum performance

The cycle time of most STEMS International search engine robots, that is the time between sampling the same web site and incorporating any changes into the STEMS International search engine's database can be a significant period of time—as long as several months. Moreover, if a particular site is not accessible when a robot comes around to examine it, the robot will not index the web pages on that web site until some future time. In the worst case scenario, the URL pointing to the web site (including any URLs to any of its web pages) could be excluded from the STEMS International search engine's database entirely. As more web sites come online, the amount of time for a STEMS International search engine's robot operation to cover the entire Internet continues to increase, requiring additional computing resources.

It is clear that the time-delay between indexing and reindexing any one content resource, e.g., a web page, leads to information stored in the STEMS International search engine's database that is stale, e.g., outdated or not “fresh” URLs. At this time, over a given time period, an equal amount of computing resources are dedicated to refreshing each link stored in the STEMS International search engine's database. However, given the large number of dynamically changing Internet resources to monitor, and only limited resources (bandwidth and storage) available to do the monitoring, there is a need in the relevant technology for a system and a method of deciding which resources should be updated first and when.

An illustration of a client-server network containing a STEMS International search engine server is shown in FIG. 1. Network 11 connects various computational devices, such as STEMS International search engine server 15, clients 17, and information transportation content servers 42. Although these computational devices are shown outside of the oval representing network 11 for clarity, these devices are actually a part of the network as well. In the embodiment of FIG. 1, network 11 is the World Wide Web, and may include millions of web transportation content servers 42, represented collectively by the surrounding dashed line, located anywhere in the world. Each transportation content server may store, or “host”, one or more web sites 13. Each web site includes one or more web pages, as described above. Transmission media 26 are used to connect the STEMS International search engine server, clients, and transportation content servers hosting the web sites to network 11, which includes other transmission media and computational devices interconnected all over the world. In a typical searching sequence, communication is established over network 11 between a client 17 and STEMS International search engine server 15, typically using a web browser program on the client. Search criteria are entered by a user of the client machine, and transmitted to the STEMS International search engine server. The STEMS International search engine server searches the information available on the network, including the information transportation content servers 42, for transportation files, forms, or document s relevant to the search criteria. This is typically done by searching a database stored on the STEMS International search engine server, where the database includes previously-formed entries corresponding to web pages accessible over network 11. The results of the search are transmitted back to the requesting client. The client may then, for example, access particular web pages included in the results directly over network 11, as desired by the user.

The large and constantly expanding size of the Internet and World Wide Web presents difficult challenges for using STEMS International search engines in the above-described process. For example, most engines are at this time, unable to index (create database entries for) the entirety of the transportation files, forms, or document s available on the Internet, or even a substantial fraction of these transportation files, forms, or document s. The storage space and computational time constraints which limit the ability of the engines to index transportation files, forms, or document s may also limit the complexity of the database entries for transportation files, forms, or document s which are indexed, such that only a rough categorization and/or analysis of search results may be performed. This may create various problems for a user of STEMS International search engines, including excessive numbers of “hits”, or transportation files, forms, or document s matching the search query, returned by the engine.

The transportation files, forms, or document is returned in response to a search query may also be incorrectly matched to the subject of the query, and incorrectly or insufficiently categorized, if categorized at all in a way apparent to the end user. In some cases, for example, priority of search results returned may be influenced by factors such as advertising revenue to a STEMS International search engine's web site. Resource limitations on the STEMS International search engine server often prevent the use of algorithms which might improve the accuracy and categorization of search results. However, the algorithms for categorization and searching are often very good, particularly the ones utilizing techniques from the field of artificial intelligence. The fundamental problem is believed to be the resource restrictions on the STEMS International search engines. Hence the STEMS International search engines often use “quick and dirty” algorithms for categorization and searching. Typically this involves examining only a few keywords or hyperlinks in a Web page and rapidly returning the results. Incremental classification is often done in a semi-automated or manual fashion.

It would therefore be desirable to develop a system and method to improve the accuracy of network search results without increasing resource requirements for a STEMS International search engine server. The desired method would allow improvement of the results of both a current search and future searches involving a topic.

Processes are constructs that store definitions descriptive of a particular task to be performed. The task to be performed is described using one or more protocols and/or one or more other processes. By this definition, a process is a grouping of protocols and other processes, wherein the functions described by the protocols and processes will perform a desired task. Processes may further include logical statements written in any scripting language, and which are included to perform error and recovery operations for the centralized transportation vehicle. Like protocols, processes are written in a generic format that identifies a type of software module that can be the target of the task of the relationship between the centralized transportation vehicle and the end users, but does not identify a specific software module or modules on which the task is to be performed from local computers. Again, the end users here include servers.

Processes can be used to develop Plans for industrial standard transportation excellent maintenance solution for directing and supplying information unique to transport motors and also enabling transportation telecommunication through a web based facility, wherein a Plan is a developed script that may be executed by a script engine for the centralized transportation vehicle to complete the task described by a connected process. The web based facility will enable on-line services to transportation vehicles by handling transportation preventive maintenance programs and the web based facility will also enable prescribed solutions to failed transportation vehicle components in accordance with DOT and equipment manufacturer's format. Plans may also be created by users having a minimal amount of system knowledge by utilizing the contained software for the web based facility to generating transportation preventive maintenance inspection programs and forms, and for enabling solutions to transportation component failure without any physical connection to the transportation vehicle. This is accomplished by an automated Plan development tool that polls the user to select a Process to be developed into a Plan.

The polling can be done using natural language expressions stored within the Processes themselves and comprising interface switching connected to the server database or warehouse for designating range of assigned characters in text and binary comparison with coded characters in the database in response to queried input for enabling transportation network and online communication and solutions to queried information. In addition, the user can be polled for the software modules that are to be operated on and/or created by a selected Process. This is accomplished using the Process information indicating the allowable types of software modules that may be associated with the Process to enable a web based server and a computer to be coupled to further enable interface switching for connecting an input signal from an end user to a network computing terminal based on at least a condition. In this manner, a user can initiate the execution of complex operations without understanding the complexities of, or the interrelationships between, tools and tool interfaces. Furthermore, the condition being in accordance with user security number, wherein the security number is stored such that centralized transportation network terminals, in accordance with other selected conditions, enables entry capable of accessing contents within the database on selected user security corresponding to the conditions, and wherein the user need no understand of the interdependencies existing between the software modules that are to be the target of the initiated operation. Plans further include a designation of the software modules that are to be used as input and output parameters of the various task. A Plan may be provided to a script engine for the centralized transportation vehicle for execution either immediately after the plan is created from a process, or on a scheduled basis through a controlled means for relocating range of assignment while maintaining a defined task in exchange for at least a solution.

In the preferred embodiment, the Protocols, Processes, and Plans are each stored as vehicle in the transportation management system repository for updating connectivity to the database, for updating the range of assignment when a connection is disabled or enabled, and for processing signal connectivity to updating execution of prescribed functions corresponding to updating functions in response to the operational set mode signals for generating matching solutions to defined failed components. This vehicle, which may be referred to as Centralized transportation System Components, are stored in a manner that is similar to the way in which the Asset components describing the software modules are stored. Furthermore, the associations between Protocols, Processes, and Plans are stored as relationships between the respective centralized transportation vehicles in a manner that is similar to the way relationships between the software modules are represented.

Representing the Protocols, Processes, and Plans as a centralized transportation vehicle within the transportation management system has several advantages. First, a step by step directory to finding defective components is enabled and providing solutions for repairing the defective component is further enabled all through a web based online analytical rundown of transportation failure and providing industrial quo solutions to enabling vehicular preventive maintenance. Next, ensuring industrial transportation safety by means of online distribution of transportation data and providing solutions to mechanical and electromechanical component failure, and further supplying thorough transportation analysis through a system of network distribution to the transportation industries, distributing at least a routine transportation safety procedure online. The transporting safety procedure includes equipment such as transport planes, transport vehicles, and marine equipment, executing standard preventive maintenance inspection and enabling at least solutions to failed components.

Some of the same tools that are used within the system to create, update, manage, and view the Asset components can be used to perform similar functions on the transportation system's components failure analysis. The tools also include a system for assembling solutions and enabling a preventive maintenance program from at least the fuel consumption data collected from each vehicle. The relationships existing between the various System components allow an end user or an automated development tool to readily discover the interdependencies existing between the constructs, expediting communication to a database warehouse describing plurality languages to files containing compiled component failures and solutions to fixed transportation maintenance program, invoking master database and variable PDL file descriptions in conjunction with queried text for online procedures. Online procedure imposes activation of the master database and variable PDL file context, enabling online transportation solutions through web based routing of transportation topics of information. This is valuable when performing impact analysis of transportation topics of information, including failure analysis after a modification is made to one of the Transportation System components. Additionally, the repository interface includes automated functions that can be invoked by both the automated Plan development tool and the script engine for the centralized vehicle to simplify Plan development and execution transportation topics of information.

The centralized transportation vehicle uses Internet or the World Wide Web as its vast repository of information that is extremely distributed internationally and locally by means of identifying transportation topics of information, the location and manner in which the information was produced. The transportation topic of information is extracted from the Web by the centralized transportation vehicle and enables individual users to traverse or surf the Web to locate the solution for the transportation topics of information of interest and manually extract the information unique to the topic. The centralized transportation vehicle for routing transportation topics of information is an innovative technique for extracting transportation information from a centralized database, extracting relevant information automatically with minimal human intervention.

In another preferred embodiment, the definition of the Centralized Transportation System Vehicle is a central driven engine for routing transportation topics of information to enable a centralized network for transportation industries. This means that each of the Centralized Transportation System Components, as well as the relationships that may exist between the components, are created using a pre-defined element type of the transportation vehicle or relationship type definition that is also stored within the repository. In one embodiment, the invention provides a computer implemented method of extracting and sharing transportation topics of information from a database. The database is searched for occurrences of at least one topic of information. An occurrence of a topic of information that was found is analyzed to identify a pattern in which the topic of information was stored. Additional topics of information are extracted from the database utilizing the pattern. In some embodiments, the process is repeated until a predetermined number of topics are found or until no new patterns are identified. The model definition both simplifies the system design and makes operation more robust because the various tools in the system can be synchronized with the element and relationship type definitions instead of having to be aware of special-case and particularized element descriptions. Additionally, modifications to the components can be more readily accomplished because a whole class of element definitions can be modified by making a single change to an element type definition. The type definitions also allow the automated Plan development tool to efficiently query the user for process and Asset element selections.

Another aspect of the current invention involves the recordation of Plan execution status. Plan Execution Record constructs are created after the execution of any Plan. These constructs are stored as Transportation System components for recording information and status about Plan execution that are useful in transportation files, forms, or documenting the software development process for standard transportation excellent maintenance solution.

The centralized transportation vehicle and advantages of the present invention will become readily apparent to those skilled in the art from the following detailed description of the preferred embodiment and the drawings, wherein only the preferred embodiment of the invention is shown, simply by way of illustration of the best mode contemplated for carrying out the invention. As will be realized, the invention is capable of other and different embodiments, and its several details are capable of modifications in various respects, all without departing from the invention.

### SUMMARY OF THE INVENTION

Fighting terrorism is a value that is more important to the world than how the world perceive privacy right. The most important problem facing the world today is not privacy right, but rather, the constant involvement of terrorist activities in non-combat environment. The centralized transportation communication vehicle is an engine for re-enforcing terrorist monitoring in a transportation crime enforcement network both locally, nationally, and around the world.

The present invention relates to a centralized transportation communication vehicle for enabling transportation industries, garages, transportation maintenance fleet STEMS, government agencies, police department, fire department, and homeland security agencies to talk to each other seamlessly through a centralized system and for extracting transportation topics of information from a centralized transportation database having information relating to different makes and models of transport vehicles. This invention further relates to management and sharing of transportation information through networks of computational devices, and more particularly to generating request of transportation information and retrieving responses to transportation topics of information such that enhancement of, and identification of relevant transportation topics of information is made accessible using such a network.

The system integrates seamlessly with all existing transportation industries, including car rental companies and all garages in the nation and around the world through their local existing systems and enabling these systems to talk to each other and communicate better in real time interaction, real responsive, real resourceful and real responsible to transportation system analysis, preventive maintenance scheduling and reprogramming, and monitoring of a terrorist activities in a centralized transportation database through at least a name search. Detected data referencing at least a terrorist desiring at least a transportation topic of information is made available to the government and/or homeland security agencies, enabling these agencies to thwart transportation and other activities involving said terrorist. The database provides data which are monitored by at least a cache. The cache enables finding other patterns in which said terrorist carries other activities.

The centralized transportation vehicle is a STEMS International search engine tool to facilitate locating the desired transportation topics of information in a network such as the STEMS WEB-SITE. An end user usually would have to access the STEMS web site that will hosts the centralized transportation vehicle or STEMS International search engine for routing transportation topics of information and submits one or more search queries related to the information type. Generally, this STEMS International search engine is a computer program that when queried for transportation topics of information, retrieves either related information or pointers to the location of related information, or both, by evaluating the STEMS server database. STEMS is a “Standard Transportation Excellent Maintenance Solution” for all transportation vehicles.

The present invention is a centralized transportation vehicle having a STEMS International search engine system that includes an entity extractor, a categorizer, and a query generator for managing and sharing transportation activities such that when a topic on transportation information is queried, responses are retrieved to enrich transportation preventive maintenance scheduling, generating solution to queried transportation component failure and analyzing failed transportation component through a centralized database. The entity extractor identifies a set of entities as described in the transportation topic of information through selected transportation files, forms, or document content for enabling searching the information related thereto using an information retrieval system. The classification label corresponds to a category of topics of transportation information in the information retrieval system. The categorizer assigns the selected transportation files, forms, or document content a classification label from the organized classification of transportation component content. A query generator automatically formulates a query that restricts a search for transportation topics of information at the information retrieval system for the particular information concerning the set of entities to the category of transportation topics of information in the information retrieval system identified by the assigned classification label to enable speedy responses to transportation information from the centralized transportation vehicle.

The entity extractor identifies a set of entities in selected file content for searching transportation topics of information related to transportation operation and maintenance through an information retrieval system. The files are requested from server computers, or web servers. A server hosting web page for the centralized transportation system is connected to the Internet and the transportation topics of information are routed by the transportation vehicle or STEMS International search engine to the server for retrieval of information specific to the queried transportation topics of information from the server database. Generally, a database system is developed and a STEMS International search engines and directories would route all the transportation topics of information to the server containing the database developed to aid users in finding specific types of information unique to transportation vehicles preventive maintenance and safeties.

The STEMS International search engine, which is often used to describe any such database system, distinguishes itself from directory in that, it routes all transportation topics of information from the internet to the database server, collecting transportation topics of information automatically using programs such as spiders, robots and/or crawlers, which will visit the centralized transportation web page and collect the needed data by downloading files in relation to the queried topics of information and also process the files. At this time, available STEMS International search engines include engines by AltaVista, Google, Yahoo, and Excite. The centralized transportation vehicle is a process-driven transportation management system for managing data relating to transportation codes and modules. In one instance of the invention, STEMS will link computers in the transportation industries and transportation technologies together by directing end users to transportation topics of information through the centralized transportation vehicle, making it easier for employees of these industries to share files and data resources through a centralized transportation network system.

The centralized transportation vehicle includes a centralized transportation system. The centralized transportation system includes server-based network to enable reliable solutions to local and distance transportation industries. The Web context will be based on queries, such that, when a user submits a query containing transportation topics of information, the STEMS International search engine will respond with a list of links pointing to information resource for the STEMS web page hosting derived from matching entries on transportation topics of information in the STEMS International search engine's database. The centralized transportation network system uses direct attached storage to the server hard drive having a network attached storage to consolidate files stored. The centralized transportation network system also uses a server adaptor to maximize productivity and end user longevity by allowing end users to always stay connected through the STEMS International search engine.

The centralized transportation network system uses at least a switch to connect client system and servers together to create a client server network within the system. The backup allows the centralized transportation system access to remotely recover any lost file. This transformation provides a process-based interface to transportation topics of information with end users. Although most STEMS International search engines utilize computer applications called spiders or robots to index the different elements of web sites on the Internet and gather content information for their STEMS International search engine's databases, none of these STEMS International search engines addresses content of Transportation topics of information. Essentially, a STEMS International search engine robot indexes a significant number of all the transportation topics of information resources in the Internet. Ordinarily, the robot will update the links in the transportation STEMS International search engine's database in a queried dependency manner so that transportation topics of information are better shared to: Enable corporate privacy control and prevents confidential information

Network connects various computational devices, such as STEMS International search engine server, clients, and information transportation content servers. Each transportation content server may store or host one or more web sites. Each web site includes one or more web pages, as described above. In a typical searching sequence, communication is established over network between a client and STEMS International search engine server, typically using a web browser program on the client computer. Search criteria are entered by a user of the client machine, and transmitted to the STEMS International search engine server. The STEMS International search engine server searches the information available on the network, including the information transportation content servers for transportation files, forms, or document s relevant to the search criteria. This is typically done by searching a database stored on the STEMS International search engine server, where the database includes previously-formed entries corresponding to transportation contents which are made accessible over the network.

The present invention provides innovative techniques for extracting transportation topics of information through search patterns from a database such as the Web. One can begin with one or more topics of information that act as the initial seed for the search. The database or databases is searched for occurrences of the topics and patterns are identified in which they are stored. These patterns are used to extract more topics from the database and the process can be repeated for the new topics. Information can be extracted from a database efficiently and accurately with little or no human interaction. In one embodiment, the invention provides a computer implemented method of extracting information from a database. The database is searched for occurrences of at least one topic of information. An occurrence of a topic of information that was found is analyzed to identify a pattern in which the topic of information was stored. Additional topics of information are extracted from the database utilizing the pattern. In some embodiments, the process is repeated until a predetermined number of topics are found or until no new patterns are identified.

In another embodiment, the invention provides a computer implemented method of extracting transportation topics of information from a database. The database is searched for occurrences of topics of information. Occurrences of the topics of information that were found are analyzed to identify a pattern in which the topics of information were stored. This pattern includes a prefix text, a middle text and suffix text, where the prefix text precedes desired information in the topics of information, the middle text is between desired information in the topics of information and the suffix text follows desired information in the topics of information. Additional topics of information are extracted from the database utilizing the pattern and the process is repeated for additional transportation topics of information.

Other features and advantages of the invention will become readily apparent upon review of the following description in association with the accompanying drawings.

### BRIEF DESCRIPTION OF THE DRAWINGS

FIG. 1 illustrates an example of a transportation communication vehicle in a server system that is centralized and utilizes a cache engine, an indexer, and at least another server in a network to execute the software of an embodiment of the invention.

FIG. 2 illustrates a system of network with web-enabled devices of the centralized transportation vehicle.

FIG. 3 illustrates a network of multiple computer systems such as the Internet, a decision engine, a wireless device and a server system in a network.

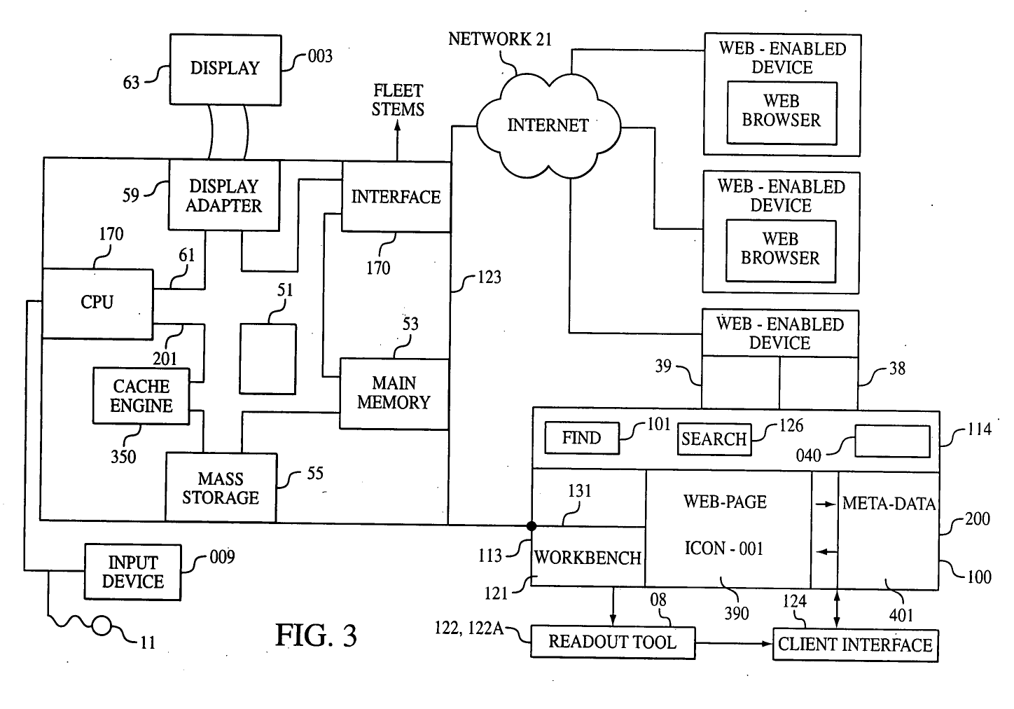

FIG. 4 shows a flow chart of at least a process of extracting transportation topics of information from a database.

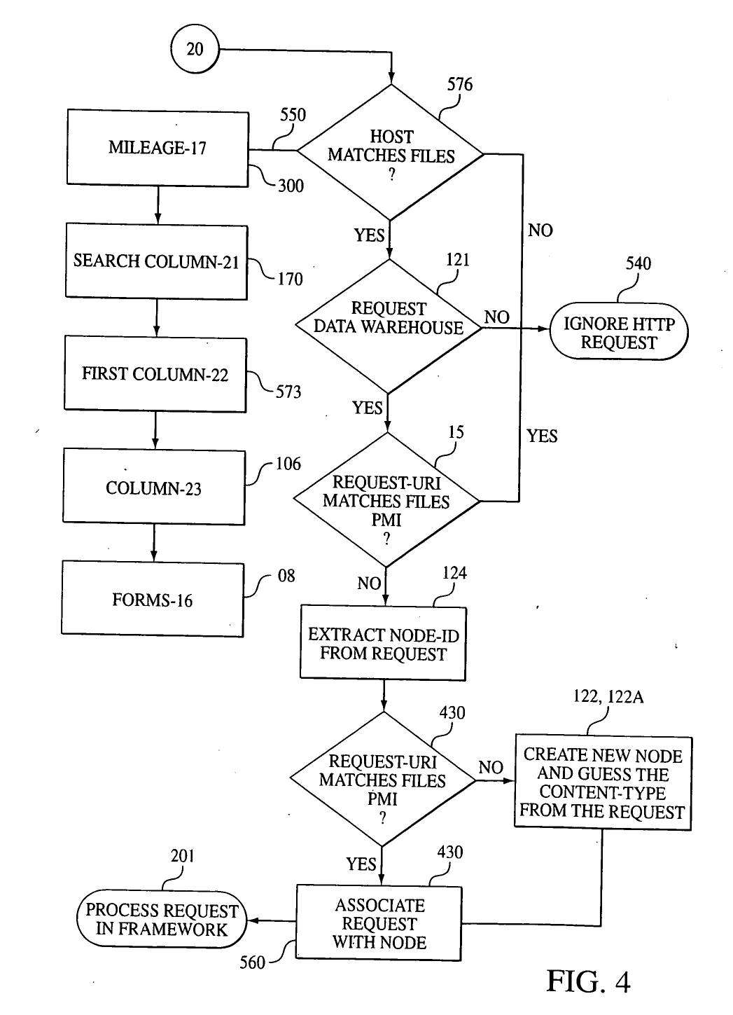

FIG. 5 shows an example of an embodiment of the invention routing information in a network and showing another process of extracting information from a database.

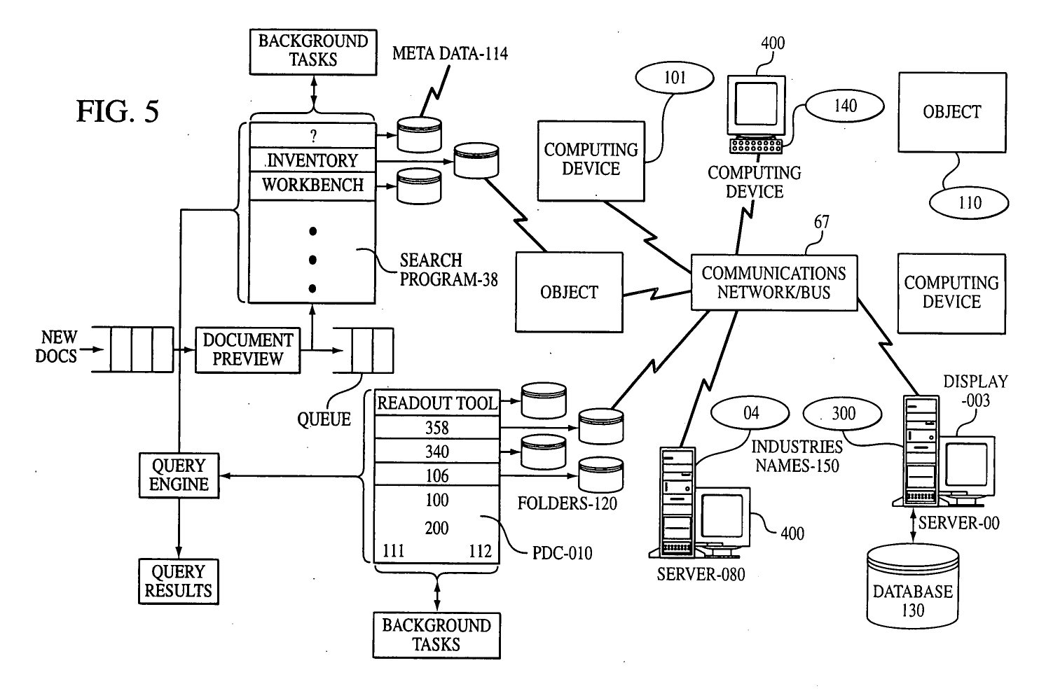

FIG. 6 shows a circuit of a process of identifying a pattern from topics of information that have been found in a database.

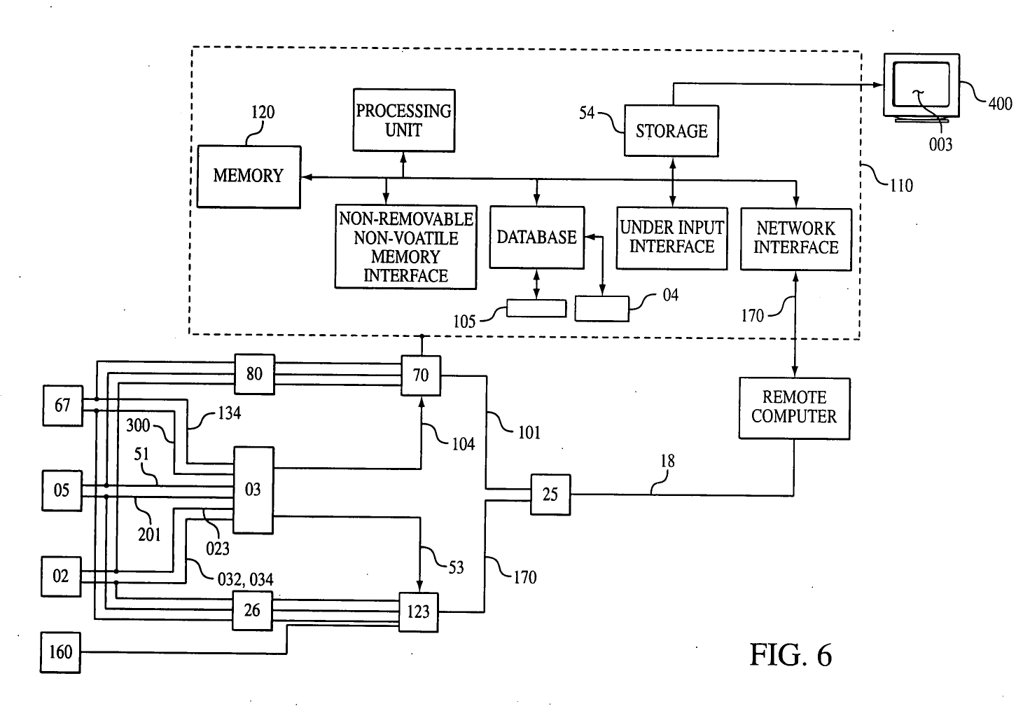

FIG. 7 shows a table of initial topics of information to be searched in a database and a process of verifying a topic of information in a network.

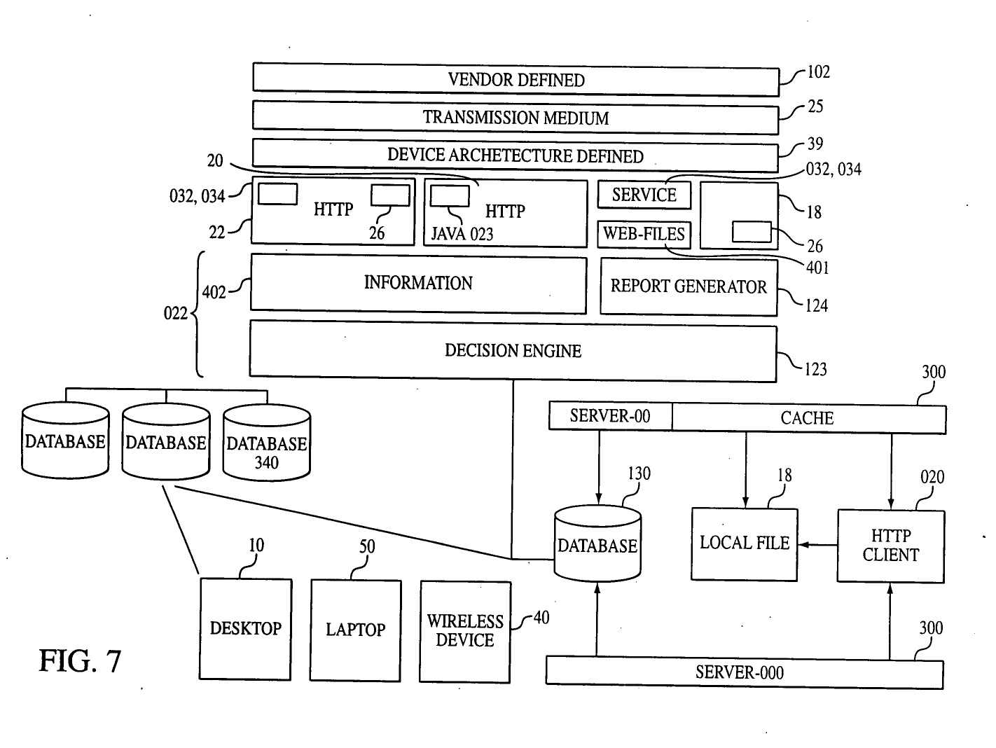

### DETAILED DESCRIPTION OF PREFERRED EMBODIMENTS

The present invention relates to a technology for providing comprehensive analytical application solutions for transportation technical support through a centralized transportation system. Its services allows industries and corporations to research on transportation topics of information for retrieving solutions for transportation vehicle's failures from a desktop computer (10), a network computer (20), a hand held computer (30), wireless devices (40), and a laptop computer (50), through its server (00). The server is always in constant communication with a centralized transportation vehicle that routes all transportation topics of information to the server through its software (300). The software also function as the operating system for the server (00), and the applications that enable communication with other devices and computers, for enabling response to transportation industries research request. The software (300) allows the server tools (01) to communicate with each other while the application permits users to perform search task. The tools (01) enable communication with the ROM (02), while allowing the software (300) to communicate with the hardware (04) of the server computer (00), enabling security and reliability on the industrial files (110) and folders (120). The file (110) or folders (120) are created in another database (130) through a primary domain controller “PDC” (010), or another set of file/folder server for keeping industrial or corporation's records. The PDC (010) centralizes all the industry's computers from a cable (130) through network adapters (160) or wireless communication device (40), enabling a centralized transportation communication vehicle for allowing transportation industries, garages, transportation maintenance fleet STEMS, government agencies, police department, fire department, and homeland security agencies to talk to each other seamlessly through a centralized system and for extracting transportation topics of information from a centralized transportation database. The database has information relating to different makes and models of transport vehicles.

The invention further relates to a centralized transportation searchable vehicle for enabling searching the web for topics of information relating specifically to any make and model of transportation equipment in order to identify preventive maintenance and repair patterns of that particular equipment in which the topics were stored so that additional topics can be extracted from the database to aid file sharing within various transportation companies. The system integrates seamlessly with all existing transportation industries, including car rental companies and all garages in the nation and around the world through their local existing systems and enabling these systems to talk to each other and communicate better in real time interaction, real responsive, real resourceful and real responsible to transportation system analysis, preventive maintenance scheduling and reprogramming, and monitoring of a terrorist person's activities in the centralized transportation database (130) through at least a name search. Detected data referencing at least a terrorist desiring at least a transportation topic of information is made available to the government and/or homeland security agencies, enabling these agencies to thwart transportation and other activities involving said terrorist. The database (130) provides data which are monitored by at least a cache engine. The cache engine enables finding other patterns in which said terrorist carries other activities.

The network adapters provide the physical connection to the network, locating the physical addresses of industrial computers or other devices. The PDC (010) receives the industry's name (150), and password (140), at the initial logon screen (400), and create security identification that will set the permission and rights for the industrial services. Connectivity is allowed through protocol communication, permitting data to be sent through network adapters (160) into cables (130) or other wireless means. The network interface (170) pulls out or put into network adapters (160), the data through the cables (130) with no internal protocol. The communication process from one computer to a network, to retrieving data, passes through model layers that are assigned specific task to the layers. The application layer (530) supports files, application services, print services, message services, and database services before they are sent to the presentation layer (540) to convert and code the data.

After the data are coded, they are then sent to the session layer (550) to manage all the communication process to the transport layer (560). The transport layer (560) delivers the data to the end user. The network layer (570) enables data to be moved over the Internet through routers. The Internet protocol layers (410) encapsulate the search packages into data-gram that will run through its algorithms into the database problem and solution addresses (131). The problem and solution addresses (131) is enabled by the transport protocol (420), which provides communication between computers, or the default gateway (430), which allows computers in a network to communicate with computers outside of the network. Its digital information to e-commerce transportation solutions enables imperative mainframe for absolute maintenance, sharing dominance to improving standards and competitive safety over transportation industries (100) and corporations (200) maintenance programs through a centralized transportation system. When transportation equipment (340) experiences any type of a failure, industries (100) and corporations (200) will enable STEMS services through the centralized transportation system by clicking onto STEMS icon (001) to receive entrance into the centralized system. When the icon (001) is clicked, a screen (400) is enabled and a search column (21) will pop-up on the screen (400). The first column (22) is operationally configured with column (21) to identify the type of equipment, while enabling the failed component topics of information to be entered on the search column (21) responsive for identifying the restricted area of the search.

A detailed description of the behavior of the failed component is next entered in column (23). After column (22) and column (23) are entered, another key, the enter or connection key (25), is clicked to allow communication between STEMS server (00) and the desktop computer (10), the network computer (20), the hand held computer (30), wireless devices (40), and the laptop computer (50). The server (00) is another set of computer at a network station (35) that is operatively configured to process and communicate with all the requested information and also controls all communications at the station. The server (00) will receive the information from column (22) and column (23) and matches the columns with the components at its data warehouse (121). The data warehouse (121), which is a memory where all the transportation data are kept for searches and retrieval, reads the information, code it, and match each coded problem with its coded solution.

The components (350) have all the possible failed problems at the warehouse (121), so that when the information on column (23) is received at the network station (35), the server central processing unit “CPU” (03) will enable the ROM (02) to be active. The ROM (02) is operatively configured with the CPU (03) and logically reads the transportation topics of information on column (23), assigns a matching code to column (23), and match the solution code to the problem code. Industries (100), corporations (200), fleet STEMS will then receive the solution code in text format and enjoy the global trading solution for DOT standard requirements and rundown solutions to correcting the failed components (350). The distribution of the solution code for failed components (350) will enable participation in the open data sharing activities for all types of transportation equipment (340), and also improves maintenance applications to the equipment (340) through a centralized transportation system. The shared information about the solution code is the excellent solution that is read to the end user as the possible solution. Necessitating the openness to real solutions is inescapable to safety and maintenance standard. Therefore, the coded solution is digitized and the digital transformation to e-commerce transportation innovative technology for solutions will enable absolute maintenance for its market share, advancing safety and maintenance standards to the industrial environment through this centralized transportation system.

This invention allows maintenance to be the key factor to the transportation breakthrough into e-commerce. The invention's cutting edge in electronic business to a centralized transportation system's services enables participation in the open trading of its activities with industrial partners, generating preventive maintenance inspection “PMI” programs (15) and forms (16) from the compiled mileage (17) of the individual equipment (340). The software (300), upon receiving the compiled mileage (17) information, assigns the RAM (05) to locate the industries complete address, and a letterhead is generated. If the mileage is in addition to the preset number set alternate, the software (300) will enable a readout tool (08) that will then initiate a PMI printout form (16) for the particular equipment. The ultimate destination of the printout forms (16) depend entirely on the state of the openness between existing transportation industries connection to the centralized transportation system and the digital marketplace, which allows printout through the industry's printers by the recognition of protocol addresses and password.

In other embodiment of the description, the present invention is described in reference to embodiments that extract transportation topics of information and routing patterns from the Web. Server (000), which is a Centralized search Vehicle and Management System, is communicatively connecting other systems, which further includes Common Fleet STEMS 110 to function and aid the end user in understanding the relationships between components and component failure, and also aid in invoking the tools used to perform the transformation and renovation operations through the centralized transportation system. Server (000) and (00) are operatively configured with a cache and communicatively connected to a query engine. The cache provides easier and faster means of desired content for transportation topics of information. The cache engine identifies transportation topics contents in a user selection within a network. The cache engine downloads content that matches user defined preferences and enables communication with the servers (000), (00) for data transmission. The servers are embodied in the system through which at least a background task is enabled to allow a posting for allowable task to be performed by at least a registered user.

Server (000), (00) are further configured with at least a registration module, a monitoring module, a search module, and a communication module communicatively connected to at least a database and operatively configured with a network through a remote terminal. The network further includes the Internet connected to at least a web-enabled device having at least a browser operatively configured with a cache engine communicatively connected to a client Each user may be allowed to at least an object in the system. An object may include content of the database which is access-able through a communication network or Bus. Objects and documents are queued and searchable in a network through the Internet and the indexer operatively configured with the index manager communicatively connected to a content store receives and transmits query postings to enable results from the server (000), (00). Results are enabled through a processing unit configured with a memory and connected to at least an interface. The interface is operatively configured to communicate with remote computers communicatively connected to at least a server. Server (000), (00) are transportation search engine responsive for routing transportation topics of information and transportation contents.

Server (000), (00), and the query engine are further configured with filters operationally connected to nodes. The system for the Common Fleet STEMS 110, government agency (111), garages (112) etc. is linked to the centralized transportation system through the web. The centralized transportation system includes the Affinity Analyzer 122, which is a tool that analyzes the relationships existing between various components contained within the transportation component Inventory 102. The Affinity Analyzer determines which components are involved in the processing performed to accomplish a particular function or task associated with transportation topics of information. The Affinity Analyzer 122 further provides a graphic display representing the various components and element relationships for those code and data components provided by the database platform. The graphical displays are capable of illustrating complex element of transportation components drawings through networks and are also used for advanced impact analysis of the transportation topics of information to enable solutions for queried data. The system allows code modification and before a particular code module is modified, the relationships existing between the associated elements that models that code module and other components may be used to determine which other code or data components need to be modified to maintain system's compatibility and efficiency so that all other end users would communicate through the centralized transportation system seamlessly and in real time. These relationships may be graphically depicted using the Affinity Analyzer 122, which allows software analysts to interrogate and visually mine single or disparate sets of components without having to understand the details of the components or relationships involve.

The centralized transportation vehicle contains Common STEMS, which comprises the Element Locator 124. This tool uses Natural Language Understanding (NLU) technology to locate potential solutions for the failed components in the transportation database warehouse. This makes the transportation topics of information stored in the memory more accessible to other user environments because the details of the stored information or the structure of the information have to be known outside the centralized system. The Element Locator 124 is operatively configured with the component inventory (102) and communicatively connected to the Affinity Analyzer (122) to enable performing a very efficient concept such as search, using application domain mappings stored in the system's database shelves (70).

Also included in the Common STEMS 110 is the Process Manager 126. The Process Manager is rules-based tool that allows a user to define the centralized transportation vehicle or protocols and enable various processes that are in the database shelves (70). These centralized vehicle provide a mechanism whereby a user can invoke scripted tools and certain other functions provided by the centralized transportation vehicle process manager (126) without being familiar with the actual tool interfaces associated with the tool invocation.

A user accesses both the Common STEMS 110 and the Overall-Specific STEMS 108 through a graphical user interface as the Common Workbench (113). In the preferred embodiment, Centralized Vehicle Management System (000) is a web-based system having a “web-like” interface, although other types of interfaces, graphical or non-graphical, could be utilized. With these transportation vehicles, a user can invoke scripted tools by specifying a desired outcome instead of by specifying particular tool sequences. Thus the complexity associated with locating, transforming, processing, and managing the code and data modules of various transportation fleet departments files are largely hidden from the user. However, any resulting program(s), having computer-readable program code, may be embodied within the centralized transportation system or within the users such as the server or more computer-usable media such as memory devices or transmitting devices, thereby making a network of fleet computer program products or transportation topics of information involving articles of manufacturer per modeled vehicle according to the instant invention.

As such, the terms “article of manufacturer” and “fleet computer program products” includes pre-trip and post-trip of a vehicle, preventive maintenance of a vehicle, a rundown of vehicle history to generate appropriate maintenance per operational locked down of the vehicle as used herein, and are intended to encompass a computer program existent either permanently, temporarily, or transitorily on any computer-usable medium such as on any memory device or in any transmitting device capable of enabling communication through the Internet. Executing transportation vehicle program code directly from one medium, storing the transportation vehicle program code onto a medium, copying the transportation vehicle program code from one medium to another medium, transmitting the transportation vehicle program code using a transmitting device, or other equivalent devices may involve the use of a memory or at least a transmitting device which only embodies program code transitorily as a preliminary or final step in invoking preventive maintenance forms and other solutions to failed vehicle components from a server database to enable directing safe vehicles on the public highways or airways.

The memory devices for the centralized transportation system include, but are not limited to, fixed hard disk drives, floppy disks, or zip diskettes, optical disks, magnetic tape, semiconductor memories such as RAM, ROM, Proms, etc. Transmitting devices for the centralized transportation system include, but are not limited to, the Internet, intranets, electronic bulletin board and message/note exchanges, telephone/modem based network communication, hard-wired/cabled communication network, cellular communication, radio wave communication, satellite communication, and other stationary or mobile network systems communication links. A machine embodying the centralized transportation system may involve one or more processing systems including, but not limited to, CPU, memory and storage devices, communication links, communication and transmitting devices, servers, I/O devices, and/or any subcomponents or individual parts of one or more processing systems, further including software, firmware, hardware, or any combination and/or a sub-combination thereof, which embody the centralized transportation system and the centralized transportation vehicle for routing transportation topics of information.

Moreover, because protocol and processes are defined and managed as part of the transportation vehicle, the impact-analysis operations that are performed when tools, code modules, or data modules are modified or deleted are largely simplified to make complex task more simplified.

Also included in the Workbench (113) are functions that allow the user to manage, view, and report all the components and element relationships existing within the transportation industries. These tools include Transportation Discovery Functions (143). Transportation discovery refers to the process of initially creating components and their relationships among other components in the transportation fleet management system. Generally, a Transportation Discovery Function will analyze a target group of transportation software and data constructs and the interrelationships between these constructs. The Transportation Discovery Function will then automatically create components associated with the code and data constructs. If the Centralized Vehicle Management System (000) is model driven, the Transportation Discovery Function (143) will utilize the various element type definitions stored within the model, such as a program or database to create the components. Each of these components includes meta-data (114) that describes the location and function of the associated code or data element. This meta-data (114) will further describe the relationships that an element of the transportation vehicle has with other components, wherein each element relationship models the relationship between the associated code or data construct and other code or data constructs represented by the related components.

The Transportation Discovery Function (143) will generally sort or create a group of components that may then be stored within the Server Database shelves, and which then becomes available as part of the system knowledge base to manage the associated code and data components. More specifically, the embodiments will be described in reference to utilizing topics of information to identify patterns in which the topics are stored so that additional topics can be found. However, embodiments of the invention are not limited to any particular vehicle, application or specific implementation. Therefore, the description of the embodiments that follows is for purposes of illustration and not limitation.

The components have all the possible failed elements of the transportation vehicle, including the solutions to problems at the warehouse (121), so that when the information on column (23) is received at the network station (35), the server central processing unit “CPU” (03) will then enables the ROM (02). The ROM (02) logically reads the queried topics of information on column (23), assigns a matching code to column (23), and matches the solution code to the problem code. Transportation industries (100), corporations (200), fleet facilities, and garages receive the solution code in text format and allow global trading of DOT standard requirements and rundown solutions to correcting the failed components (350). The distribution of the solution code of failed components (350) enables participation in the open data sharing through the centralized transportation system for all types of transportation equipment (340), improving maintenance applications for the equipment (340). The shared information about the solution code is delivered online through the Internet, representing the excellent solution that is transmitted to the end users as the possible solution, thereby necessitating the openness to real transportation solutions through a centralized transportation system as being inescapable to advancing safety and maintenance standard for the transportation industries. Therefore, the coded solution is digitized to enable rapid digital transformation of transportation fleet operation into e-commerce transportation innovative technology for enabling solutions to absolute maintenance through the centralized systems market share. This transformation will expedite advancing transportation safety and maintenance standards within the industrial environment. The centralized transportation system allows maintenance to be the key factor to the transportation breakthrough into e-commerce.

The invention's cutting edge is the enabling of electronic resourceful business to transportation services, enabling participation in the open trading of transportation activities with industrial partners, generating PMI programs (15), and forms (16), from the compiled mileage (17) of individual equipment (340). The software (300), upon receiving the compiled mileage (17) information, will then assign the RAM (05), to locate the industries complete address, and a letterhead is generated. If the mileage is in addition to the preset number set alternate, the software (300) will enable a readout tool (08), that will then initiate a PMI printout form (16), for the particular equipment make and model. The ultimate destination of the printout forms (16) depend entirely on the state of the openness between existing transportation industries and the digital marketplace, which will allow printout through the industry's printers by the recognition of protocol addresses and password. In some embodiments of client-side search program 38, a graphical user interface allowing manual categorization and/or ranking of the initial search results may be included. Such an interface could include icons representing the transportation files or transportation files, forms, or document s referenced by the initial search results. These icons could be manipulated by the user with a pointing device. In one instance of the invention, the icons could be arranged in a priority sequence or sorted into categories. Icons corresponding to files determined by the user to be irrelevant to the search criteria could be deleted or discarded. The additional search results arrived at by client-side search program 38 typically is a refined version of the initial results.

In addition, the centralized transportation system through STEMS digital industrial marketplace will enable businesses operation with transportation industries, sharing and exchanging its services through the centralized transportation vehicle (000) with STEMS by routing all transportation topics of information to the central server, such as inventory of PMI, production scheduling of repairs, ordering of information from the files (110), information on cost per maintenance of industrial equipment (340), to advancing the way transportation industries conduct businesses. STEMS digital mainframe solution will thrive for transportation industries safety habits by building a thorough preventive maintenance programs from its software (300), to its client information center or PDC (010). The proliferation of the transportation digital market places will lead to the creation of advance maintenance that will develop new services based on the existing digital market functionality of STEMS through the centralized transportation system. The invention's open digital mainframe solution will also fulfill the advancement of Net Communication in the transportation e-commerce by implementing a step-by-step rundown of a preventive maintenance inspection program “PMI” (15) that will further enhance safety and eliminate cost and operational downtime.

STEMS provides the vehicle of choice for solving transportation problems over the web, advancing online destination services where other transportation businesses will take advantage of the growing variety of the centralized services, which are important to industrial efficiency, profitability, resourcefulness, and success. The invention also enables process integration with Internet Technologies that will make transportation problem solving easier, by providing a centralized digital workplace that will offer the next level of transportation solutions to topics of information in fulfilling industrial promises for safety through a common Net economy. That is, the system will provide online location center through which a company can offer and access all its e-commerce services and contents, finding and solving transportation problems through the use of its software (300), enabling a new Internet-based transportation business services. These services will expedite improvement on safety and productivity through a centralized digital transportation market supplement to existing methods. The centralized transportation system's activities are carried through the applicable modeling of tools (01), mediating between subjects and objects by defined routes, routing transportation topics of information and enabling transportation solutions to defined problems. The tools (01) also enable individual and functional creative ability of computers to interact with the server (00), routing problems and extracting solutions for the routed problems from a centralized server. When the individual accessories are processed through tools (01), objectification is enabled, allowing the columns (21), to be accessible to other tools like the data warehouse (121).

Search results are produced through the social interaction between plurality tools (01). The invention is also designed to exemplify build-in system research tools (01). These tools (01) are augmented reality to systems tools of ordinary systems developed to enhance transportation solutions with its graspable hardware (04) and software (300), which support the industries and corporations industrial planning and decision making geared for their maintenance fleets. The centralized transportation system through STEMS operation is a comprehensive centralized technical support whose product is upgradeable and includes programs that are designed to enhance industries and corporations with DOT standard e-commerce application through web based method. The applicable solutions to the centralized services are also focused on offering and providing the technical support staff with a high level of support expertise on STEMS products and services.

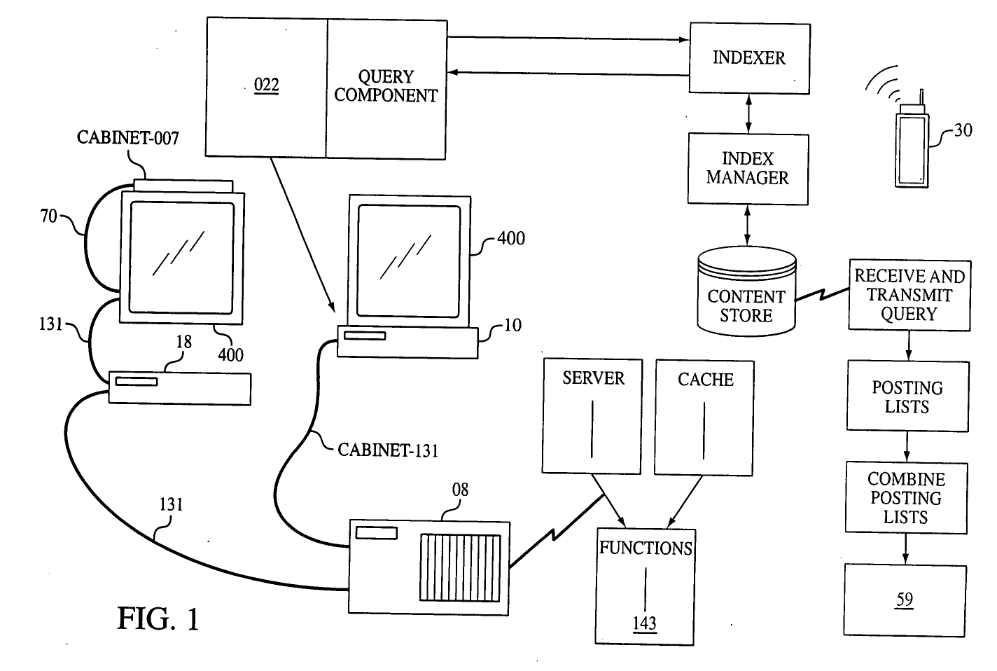

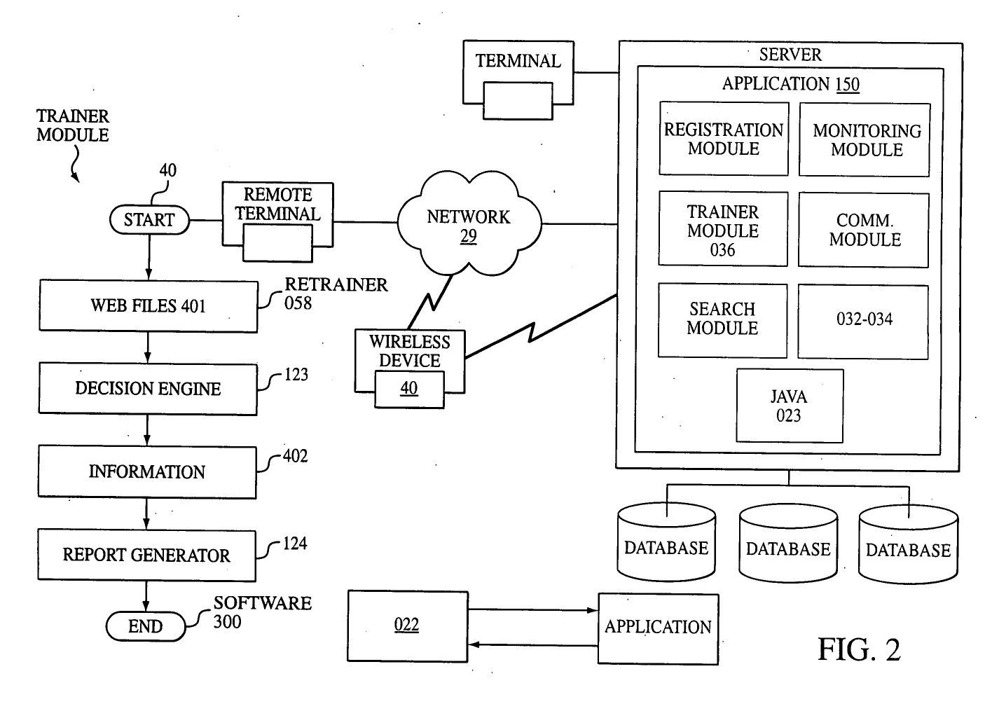

FIG. 1 illustrates an example of a computer system that is used to execute applicable software for enabling the embodiment of the present invention. FIG. 1 further shows a computer system that includes a display (003), screen (400), cabinet (007), keyboard (009), and mouse (11). The mouse (11) has one or more buttons for interacting with a graphical user interface (101). FIG. 2 shows the cabinet (007), which houses a CD-ROM drive (00), a system memory (104), and a hard drive (105), which can be utilized to store and retrieve software programs used for incorporating computer code that implements the embodiment of the invention such as coded data as specified in the invention. Although CD-ROM ((00)) is shown as an exemplary computer readable storage medium, other computer readable storage media including floppy disk, tape, flash memory, system memory, and hard drive can be utilized. Additionally, a data signal embodied in a carrier wave such as in a network, including the Internet, is the computer readable storage medium.

FIG. 2 shows a system block diagram of computer systems used for executing the software for the instant invention. As shown in FIG. 1, the computer system includes a monitor (003), keyboard (00)9, and mouse (11). The computer system (10) further includes subsystems such as a central processor (51), system memory (53), and fixed storage medium such as a hard drive (105), removable storage such as CD-ROM drive ((00)), display adapter (59), sound card (61), speakers (63), and Network interface (170). Other computer system that may be suitable for use with the instant invention includes at least an additional or fewer subsystems. For example, another computer system could include more than one processor (51) to enable a multi-processor system or a cache memory. The system bus architecture (67) of the computer system is represented by arrows. However, these arrows are illustrative of any interconnection scheme serving to link the subsystems. For example, a local bus could be utilized to connect the central processor to the centralized system memory and display adapter. Computer system shown in FIG. 2 is but an example of a computer system suitable for use with the instant invention. Other computer architectures having different configurations of subsystems can also be utilized.

An embodiment of a system (000) for identifying stored information accessible using a client/server network is illustrated in FIG. 2. System (000) is a network similar to network (221) of FIG. 1, but with a STEMS International search engine server (000) and client (020) adapted for performing methods of routing transportation topics of information to STEMS SERVERS. The STEMS International search engine server (000) is a computational device which may be a web server. In one embodiment of FIG. 2, server (000) includes processor (51) and at least a storage device ((00)). Storage device or storage medium may take many forms, such as volatile or nonvolatile memory, a magnetic disk such as a hard drive or floppy drive, an optical disk, and/or a magnetic tape. Such a storage device is sometimes referred to as a direct access storage device “DASD”. Storage device ((00)) may in some embodiments be a combination of more than one storage device. In the embodiment of FIG. 2, storage device ((00)) includes files (18) and program instructions (20), also referred to as program executables for executing transportation topics of information.

The program instructions are typically stored as executable files in a storage device and are loaded into system memory during execution. Files (18) may include transportation files, forms, or document s such as web pages suitable for viewing by a user of the transportation network, and may contain text, graphics, video and/or audio information. The transportation files, forms, or document files may be in the HTML language, or in other suitable languages such as Extensible Markup Language (XML) or Wireless Markup Language (WML). Files (18) may also include plurality files suitable for use in communicating across the network or in identifying stored transportation topics of information accessible using the network. That is, a file including initial search results produced by server-side search program (20) may be included in files (18), as may a file containing data associated with additional search results from an additional search performed on a client machine.

Files, as used herein refers to any collection of transportation data suitable for storing on a computational device or transferring within a network. Program instructions (20) may include various program instructions used to implement functions of network server (00), such as program instructions used to implement the methods for sharing transportation topics of information to enable solutions to transportation safety.

Storage device ((00)) may also include server-side search program (20) and search database (130). Although search program (20) is implemented using program instructions such as executables, search program (20) is shown separately in FIG. 2 to emphasize this feature of the server. Server-side search program (20) is typically associated with a STEMS International search engine for routing transportation topics of information similar to those available for use on the Internet, such as Yahoo, AltaVista, or Excite. Search database (00) is also accessible by search program (20) for performing searches of network-accessible information. The transportation database (00) is also typically associated with a centralized transportation STEMS International search engine as described above. The transportation database may contain entries characteristic of files, transportation files, forms, or document s and/or other information stored on the transportation information content servers (00) and accessible over the network. These entries may be established in various ways, such as automatically using a spider or crawler program associated with the STEMS International search engine, or through sub overall by web site developers. Search program (20) may be adapted to receive from a client data associated with an additional search performed by the client.

Alternatively, receiving of such transportation data could be implemented using other program instructions (20). Search database (00) may be modified in response to receipt of such data from a client, so that results of future transportation topics of information searches using program (20) and database (00) may be improved. Transmission medium 25 may be used to connect STEMS International search engine server (000) to other computational devices, such as client (020) and/or information on transportation content servers (00). Transmission medium (27) may include, for example, a wire, cable, wireless transmission path, or a combination of these. Protocols used for transmission along transmission medium (27) may include TCP/IP, HTTP, and/or other suitable protocols such as Wireless Applications Protocol (WAP).

System server (000) is operationally configured with server (00) and may further include client computational device linked to server (00) using transmission medium (27). In the embodiment of FIG. 2, client (020) includes processor (51) and at least a storage device (105). Storage device (105) is similar to storage device ((00)) described above, and may include files (18), program instructions (20), a client-side search program (38) and a browser (040). Although programs such as search program (38) and browser (040) are typically implemented using program instructions or executables such as instructions (20), search program (38) and browser (040) are each shown separately to emphasize these features of the client. Client-side search program (38) may operate in a manner similar to server-side search program (20), except that instead of searching a database such as database (130), which is at least intended to be representative of information stored throughout the network, search program (38) is applied to the set of initial search results sent from server (00) to client (020). In this sense, client-side search program (38) may be considered a secondary STEMS International search engine, used to further refine the transportation search results sent by the primary STEMS International search engine of server (000). Such centralized transportation search program typically will operate by comparing user-entered search criteria such as keywords on transportation topics to the material being searched. In the case of server-side search program (20), the material being searched is typically the set of entries in search database (130); while in the case of client-side search program (38), the material being searched may be the set of initial results.

Both STEMS International search engine server (000) and client (020) are communicatively connected using a transmission medium (27) such as medium to a set of multiple transportation topics of information on transportation content through servers (00) accessible using the network. A network such as the Internet may contain millions of networked servers providing information content in addition to STEMS International search engine servers such as server (000) and clients such as client (020). Such information content may include web-pages (390), files (401), and/or other transportation topics of information (402).web-pages (390) are typically files, and other files may be stored on a network, such as files accessible using alternative protocols to HTTP, such as File Transfer Protocol or FTP. Other information may include dynamically-generated information such as responses to queries. In an embodiment for which a network is the Internet, the information on content available using transportation content servers (000) may generally be referred to as resources, or any transportation topics of information identifiable using a Uniform Resource Locator (URL) or substantially equivalent nomenclature for making the centralized transportation system more resourceful.

In some embodiments, the actual transportation files, forms, or document s or files described in the initial results may be retrieved by the client from networked information on transportation content servers (000) through transmission medium (27), before an additional search is performed. Search program (38) may in such an embodiment compare the user-entered search criteria to the actual transportation files, forms, or documents or files referenced by the initial search results. Searching of the actual transportation files, forms, or documents in this manner may be most appropriately done in embodiments for which the additional searching performed by the client is done at times of low client machine utilization, or as a background process, rather than being done real-time. To facilitate transfer of initial search results from server (00) to client (020) and transfer of additional search results from client (020) back to server (00), server-side search program (20) and-client-side search program (38) are preferably designed to be compatible. As a means of achieving this compatibility, the client-side search program may be installed on the client machine by the server-side STEMS International search engine (000) when the client first uses the centralized transportation STEMS International search engine (000). That is, each time a client or user contacts the STEMS International search engine server (000), a determination could be made as to whether the user had previously registered with the STEMS International search engine and received the corresponding client-side search program. This determination could be made by direct query to the user or in some cases automatically by exchange of information between the client and the STEMS International search engine server (000). If the user does not have the client-side program or doesn't have the proper version, the program could be installed by the server onto the client. The client-side search program could also be downloaded from the STEMS International search engine server by a client in some embodiments, possibly as a Java applet. As another possibility, the client-side search program could be supplied through communicative connection with a computer along with other software. Initial opening of the client-side search program in such an embodiment could establish a connection with the corresponding server-side search program, and allow for any initialization and information transfer needed to allow the programs to work together seamlessly.

A Centralized transportation search engine server (000) also called a Centralized Transportation search engine Management System. The Centralized transportation search engine server (000) for end users may include some or all of the features of the Centralized transportation search engine server (00). The Centralized transportation search engine server (000) may include one or more of the following: a Network interface (170), a transportation decision engine (123) operatively configured with the affinity analyzer (122), databases (130), a report generator (124), a data analyzer (122), and a payment module ((104)).

The Network interface (170) connects the Centralized transportation search engine server (000) to a network (221), preferably a computer network, such as the Internet. The Network interface (170) may also connect with networks such as wireless networks, television networks, telephone networks, satellite networks, local area networks, and other networks.

The transportation decision engine (123) provides the end user with an interactive interface to select transportation topics of information, product or services. Decision wizards, comparative product charts, and other tools may be used in the interactive interface. The transportation decision engine (65) also may provide information about the various product or services. The transportation decision engine (65) may present a series of questions to the user about various maintenance rundowns and scheduling and the features of the product or service as described above in reference to the Centralized transportation search engine server (000). Predictive networks and artificial intelligence may be used in the transportation decision engine (65).

The transportation decision engine (65) may include neural network-based algorithms that are effective in several applications including: diagnosis or pattern recognition such as speech and image processing, because the neural network algorithm is capable of adjusting to patterns in data. Neural networks can deduce relationships between the different data variables, e.g. estimation or prediction applications even when difficulties exist in completely specifying the rules for make and model vehicle. Neural networks can assess interrelationships between the factors and predict outcomes with significant accuracy. A neural network may be capable of processing large amounts of data in real-time. Once the training set for the neural network is developed, the learning algorithm trains the neural network by creating a network of associations between possible aspects of input relating to transportation topics of information and responses thereon. A neural network would be more flexible than traditional programming methods because the neural network can be scaled and can be reused for other transportation problem domains. The transportation decision engine (123) has many components and may include some of the following: 1. a Java storage and retrieval (JSTAR) Class (023); 2. a ClicknVestSetvlet class (032); 3. a servletrunner application (034); 4. a Trainer Module (036); and 5. a Retrainer Module (038).

The detailed description is directed to certain specific embodiments of the invention. However, the invention can be embodied in a multitude of different ways as defined and covered by the claims. Typically, the network (221) provides communications among at least one centralized transportation network terminal (022), at least one STEMS International, search engine server (000), and/or at least one transportation content server (00). As illustrated, the STEMS International search engine server (000) and the transportation content server (00) may also establish bidirectional communication via the computer network (20). The centralized transportation network terminal (022), STEMS International search engine server (000), and transportation content server (00) communicate via the network (221) in a manner that is well known in the pertinent technology, such as in accordance with the TCP/IP communication standard used over the Internet.

The computer network (20) may be any distributed computer network such as a local area network (LAN), a wide area network (WAN), or other connection services and network variations such as the Internet, the World Wide Web, a private computer network or intranet, a value-added network, and the like. The centralized transportation network terminal 104 may be any processor-based device configured to access the computer network 100, including terminal devices, such as personal computers, workstations, servers, secondary-computers, primary-frame computers, laptop computers, mobile computers, palm top computers, hand held computers, set top boxes for a TV, or a combination thereof. The centralized transportation network terminal (022) may further include input devices such as a touch screen (210), a keyboard (11), and a mouse (11) and further includes output devices such as the computer screen or a speaker.

The STEMS International search engine server (000) is typically a processor-based device that is programmed with instructions to route transportation topics of information and receive search queries and process them using algorithms that compare terms of the search query with the transportation data associated with each link stored in a database. ((130) The transportation content server (00) is usually also a processor-based device similar to the STEMS International search engine server (000); however, the transportation content server (00) is configured to store transportation data and to forward some or all of the transportation data in response to requests made by the centralized transportation network terminal (022) and/or the STEMS International search engine server (000). The data stored in the transportation content server (00) is typically in the form of electronic files such as the web pages built with Hypertext Markup Language or HTML which are accessible over the network (221). In one common scenario, the location of each web page stored in a web site is associated with a unique URL and communicable with the centralized transportation system's server or primary STEMS International search engine.

It will now be explained how the network (221) provides specific transportation topics of information sought by a user. Typically a user seeks to access specific transportation data stored in one or several transportation content server (00). However, often the situation arises where the user does not know which transportation content server (00), or even where within a specific transportation content server (00) the data resides. To identify the location of the desired data, the user will usually request a STEMS International search engine server (000) to identify a set of links that are relevant to the user's desired information. To accomplish this, the user utilizes a centralized transportation network terminal (022) to establish a communication session with a STEMS International search engine server (000) via the network (221). Having established this communication session, the user then inputs a query into the centralized transportation network terminal (022), which transmits the query to the STEMS International search engine server (000). The STEMS International search engine server (000) processes-the query according to any one of a number of well-known algorithms and transmits to the user a list of links pointing to information resources such as transportation files, forms, or documents on the database (130) that may be relevant to the user's query. The links are usually retrieved from a database stored in, or at least accessible through the STEMS International search engine server (000). From the list provided by the STEMS International search engine server (000), the user then selects at least one link that appears pertinent to the desired transportation topics of information.

When the user selects the link, the centralized transportation network terminal (022) makes a request to the transportation content server (00) associated with the selected link to transmit the transportation files, forms, or documents from the database (130) operatively configured with the transportation content server (00), and communicatively connected to the link which refers to the centralized transportation network terminal (022). In summary, the user employs the centralized transportation network terminal (022) to access the STEMS International search engine server (000) in order to obtain a list of transportation topic links that point to the transportation files, forms, or documents stored in the transportation content servers (00). Having obtained these links, the user access the information stored in the transportation files, forms, or documents in the database (130) by clicking the link that point to it. The transportation documents may include fuel consumption, engine mileage, engine hours, location of parts stores etc.

A block diagram illustrates the interaction via the network (221) between the STEMS International search engine server (000) and the transportation content server (00). The transportation content server (00) is the same, except that the electronic files it stores are shown as transportation files, forms, or documents from the database (130). In one embodiment, the STEMS International search engine server (000) may include a controller ((104)) in communication with a memory (1 04), an indexer (108), and a robot (109). The STEMS International search engine server (000) further comprises a link database (302) in communication with the indexer (108). The link database (302) may preferably reside in the memory (1 04), or it may be located in another memory accessible by the STEMS International search engine server (000). The indexer (108) is in communication with the robot (109). In one embodiment, the robot (109) also communicates with a queue 206 which may reside in the memory (104).

The controller (202) is configured to coordinate the functionality of the link database (130), indexer (120), robot (109), and queue 206. The controller (202) may comprise any commercially available processor, such as a Pentium Pro. The memory is conventionally connected to the processor, and may be in the form of a cache memory for rapid access to the cached or stored information, or other type of memory, such as a dedicated hard disk, or a combination of both.

The link database (130) is configured to store information typically obtained from the web site or web page associated with a given URL or link. One example of a link stored in the link database (130) is the URL http://www.STEMS.com/fleet.html. This link represents the global address of the web page “fleet.html” hosted on a transportation content server (00). The link is associated in the link database (130) with data such as text and images stored in the web page “fleet.html.” The link database (130) may be implemented with standard database management software such as Oracle's database applications.

The robot (109) is a software module that accesses the transportation files, forms, or document s stored in the transportation content servers (022), and identified by the links stored either in the database (130) or the queue (060). The Robot (109) gathers the data stored in the transportation files, forms, or document s and forwards it to the indexer (120). Software modules such as robot (109) are well known in the relevant technology. Robot (109) is also known in the relevant technology by the names spider, crawler, wanderer, or gatherer. However, in one embodiment of the instant invention, the queue (060) contains a list of links such as a subset of the links stored in the link database (130), which the robot (109) uses for updating purposes. The queue (060) may be at least a file which is preferably stored in the memory of the STEMS International search engine server (000).

The indexer (120) receives data such as web pages retrieved by the robot (109), and extracts some portion of that data that is used to associate a given link with the information on the file to which the link refers. That is, usually the indexer (120) identifies individual words from the text of a file or, in the case of a web page; the indexer (120) retrieves the text stored in the keywords or the description fields of the web page. The indexer (120) then, for each transportation files, forms, or document, associates its link with the extracted data and stores them in the link database (130). Indexing programs that perform the functions of indexer (120) are well known in the pertinent technology such as the Ultra seek Server.™. indexer produced by Infoseek Corporation.

In one embodiment, the robot (109) uses the links stored either in the link database (130) or in the queue (060) to access the transportation files, forms, or document s stored in the transportation content servers (022), and optimizes the freshness of the links displayed in response to a user query. The robot (109) then forwards some or all of the data associated with the transportation files, forms, or document to the indexer (120). From this data, the indexer (120) extracts any data it needs for association with the respective link that identifies the transportation files, forms, or document. The indexer (120) also stores the associated data and link in the link database (130). In one embodiment, the indexer (120) may compare the transportation data already stored in the link database (130) against the new data gathered by the robot (109). If there are any discrepancies in the data, the indexer stores the appropriate updates in the link database (130). In other ways, the indexer (120) concludes that the webmaster has not modified the contents or the lirik associated with the transportation files, forms, or document. The indexer (120) does not modify the contents of the link database (130). In another embodiment, however, the indexer (120) may simply inspect that the link is still valid. That is, the indexer (120) only verifies that the robot (109) was able to access any data by using the respective link pointing to a given transportation files, forms, or document. Thus, in this manner the robot (109), queue (060), and indexer (120) collaborate to refresh the contents of the link database (130).

The transportation decision engine (004) may be executed on a Microsoft Windows 95.RTM.-based personal computer or other Java compatible platform, including a Microsoft NT.RTM. server, a Sun Station.RTM., an IBM RS/6000.RTM., or other platform. The transportation decision engine (004) may be incorporated into a kiosk system.

The transportation decision engine (004) may be implemented for online Standard Transportation Excellent Maintenance Solution, transportation content and credit card processing, centralized transportation parts shopping or ware house, and other applications. The transportation decision engine (004) may make recommendation with various user survey or queries values. Because the permutations of user inputs may be large, traditional programming with logical statements would be tedious. The neural network-based transportation decision engine (004) is more appropriate than other traditional approaches, such as conventional linear programming, expert systems, and relational databases. The superior centralized decision-making of the transportation decision engine (004) would result in part from the following factors:

1. Industrial lockdown of fuel consumption data;

2. Transportation engine hour data and patterns relationships within each vehicle;

3. Simplicity of algorithm for data retrieval; and

4. Flexibility of algorithm for data distribution.

The transportation decision engine (004) can recognize patterns and relationships within a set of input data or responses of transportation topics of information and estimate and/or predict outcomes. The transportation decision engine (004) may also process a large number of variables such as queries and responses and be able to deduce the interactions between the different transportation variables. The relationships between numerous transportation variables are enhanced to formally define automobiles, trucks, planes, marine vehicles etc. in linear relationships. The transportation decision engine (004) may be trained to handle the numerous variables and can self-adapt and sort through data to produce an understanding of the factors affecting these data.

The transportation decision engine (004) may incorporate a scalable, robust, customizable, quick, simplicity, flexibility, and efficient architecture for large scale memory, retrieval, and classification problems. The transportation decision engine (004) is scaleable by adding more self organizing maps “SOMs” defining the various transportation variables and the associates variables to the training set and re-training the transportation neural network. Unlike traditional programming techniques, the transportation decision engine's programming code need not be changed. With re-training, the transportation decision engine (004) provides greater flexible without reprogramming. The transportation decision engine (004) can infer new behavior and deduce patterns and relationships in the transportation data. The transportation decision engine (004) includes two Java classes: the JSTAR class (023 and the ClicknVestServlet class (032). The JSTAR Class (023) is a Java class that is also called a JSTAR Java servlet. The JSTAR class (023) is an object-oriented, Java language based application.

Browser program (040) on client may be, for example, a web browser which allows a user to retrieve and view files on the WWW, or a program which performs a similar function on some other network. In some embodiments, client functions involved in implementation of the methods described herein are included in browser (040). For example, browser (040) preferably provides a framework for communication between server-side search program (39) and client-side search program (38), typically by calling an appropriate additional program. Browser (040) or a program called by the browser may include user-settable options as to whether additional client-side searching is done real-time or at a later time, or whether it is done at all. Other options could include whether the additional searching is done automatically by the program or at least in part manually by the user. Such functions, and/or other functions of the client computing device, may also be implemented in separate program instructions such as program instructions (26) or client-side search program (38). Files (18) may include various files stored on the client computational device, including files downloaded from information transportation content servers (00). Files (18) may also include other files suitable for use in communicating across the network or in identifying stored information accessible using the network... For example, a file including initial search results sent from server (000) may be included in files (18), as may a file containing data associated with additional search results produced using client-side search program (38). Client is typically associated with an output device (70) and input device (80), particularly in embodiments for which the client computational device is operated by a user of system (10), (20), (30), (40), and (50). Output device (70) may include, for example, a display screen (003) and/or a printer. Input device (80) may include, for example, a keyboard (009) and/or a pointing device such as a mouse (11).

The trainer module (036) trains the neural network. Training of the neural network is described below. The optional trainer module (036) may be an integral component of the transportation decision engine (004) or it may be a separate component. The transportation decision engine (004) may also be trained without a training module (036).

The optional re-trainer module (038) may use the queries, responses, confidence values and/or other factors to fine tune the transportation decision engine (004). The re-trainer module (038) may be an integral component of the transportation decision engine (004) or it may be a separate component.

The databases (130) may include vendor data, market data, and buyer data. The databases (130) may be partitioned into one or more databases, such as a vendor database (136), a user database (137), a market database (138), and transportation model and make database (139). The vendor database (136) may include information about the vendor, the products that the vendor carries, vendor specific pricing and options, and the vendor's Internet site address. The vendor database (136) may also include detailed information about the products and services offered, including price, features, brand names, delivery methods and including on-line, store front, or via distributors, availability dates, and other information.

The user database (137) may include information collected about the users. For example, the user database (137) may include information about the user such as company, business type, years in business, age, income level, gender, address (home and/or office), and planned purchase timeframe. After the user has used the Centralized transportation search engine server (000) to compare products or services, the user database (137) may include the user's preferences entered in the selection process and the user's down-selected list. The preferences of multiple users may be used to develop trend information that is stored in database (139). For example, the trend information may show that 80% of users want on-line centralized transportation parts shopping or ware house, 50% of users want interest bearing checking accounts purchase orders. After the user has purchased a product or service via the Centralized transportation search engine server (000), the user database (137)) may include information about the user's prior purchases. The user database (137) may also contain other user information such as the user's purchasing preferences obtained from other sources.

The market database (138) may include information about trends in the market place. For example, the market database (138) may include information about a trend among centralized transportation parts shopping or ware house features. The databases may include market intelligence database syndication, distribution and licensing of buyer data, vendor data, product data, and market data. Data mining techniques may be used on the databases to develop market trend data, competitive analysis, vendor profiles, and Centralized profiles.

The optional report generator (134) provides reports including vendor reports that indicate activities between users and vendors, user reports that indicate user activities with the Centralized transportation search engine server (000) and/or the vendors, preference reports that indicate trends in Centralized preferences, ad hoc reports, and others. The optional data analyzer (122a) may provide customizable data analysis tools. For example, the affinity analyzer (122) may provide customized or ad hoc data analysis that the server (00) or the server (004) can use to fine tune the marketing of the product or services.

The payment module calculates the fees charged to the vendors. Such fees may include periodic fees, banner fees, performance-based fees, and results-based fees. The results-based fees include fees based on the activities between users and vendors, when the users are referred to the vendor by the Centralized transportation search engine server (000). A user is referred to a vendor when the Centralized transportation search engine server (000) provides the user information about a vendor or a product or service offered by the vendor. User activities may include accessing the vendor's network site, opening a new account with the vendor, purchasing a product, or other activity. The fees may include fees charged to vendors other than the user's preferred vendors when the user opens an account with the non-preferred vendor. The non-preferred vendor fee may be less than the preferred vendor fee. The amount of the fee may be based on various factors, for example, the number of activities the user performed prior to at least a purchase, the user's profile, or the type of activity.

A network (221) provides communication between multiple computer systems. In a wide area network such as the Internet, some of the computer systems are servers or hosts and provide access to resources such as information or services to client computer systems communicatively connected with the network (221). With respect to the Web, there are thousands of server computer systems that store the web pages that make up the Web. The web pages typically include links in the form of uniform resource locators (URLs) that are a link to another web page, whether it is on the same server or a different one. As described above, the Web is a distributed network of web pages. Networks of hyperlinked transportation files, forms, or document s can also be present in local area networks such as the intranets. The operation of these intranets is very similar to the Internet except that it is not uncommon for all or a majority of the hyperlinked transportation files, forms, or document s of an intranet to be stored on a single server computer system.

What is claimed is:

1. A centralized Transportation search engine for routing and extracting transportation topics of information from a database such as the web and enabling computer implemented method of extracting the said transportation information to enable transportation data sharing, parts purchasing, preventive maintenance scheduling and services, and providing solutions to failed components through the web, and further includes forming a centralized transportation communication vehicle that enables communication with different systems and responsive to all different platforms, enabling the platforms to talk to one another through one centralized system that integrates with all government transportation agencies, all police stations, all fire department agencies, and all local government agencies seamlessly in real time, and wherein the centralized transportation vehicle forming a broadband for enabling a centralized transportation communication system having the capabilities to integrate seamlessly with all existing transportation industries, commercial transportation companies, all fleet and STEMS, all car rental companies and all garages in the nation and around the world through their local existing systems and enabling these systems to talk to each other and communicate better in real time interaction, real responsive, real resourceful, and real responsible to transportation system analysis, preventive maintenance scheduling and reprogramming, terrorist name search through a centralized database, wherein the centralized system's interaction with existing companies comprising the steps of:
searching the database for occurrences of at least one transportation topic of information;
analyzing an occurrence of the said topic of information that was found in the database to identify a pattern in which the topic of information was stored;
extracting additional transportation topics of information from the database utilizing at least the pattern;
providing at least one topic of information as an example of information that is desired for transportation preventive maintenance and services;
Proving at least one topic of information as an example of information for a terrorist name in said local existing system;
repeating the searching, analyzing and extracting data for additional topics of information that is desired for solving failed transportation component; and
Repeating the searching, analyzing and extracting data for additional topics of information that is desired for tracking a terrorist desiring a transportation service.

2. The method of claim 1, wherein repeating the searching is enabled for analyzing and extracting the additional topics of information until a predetermined number of topics of information is extracted, and wherein the pattern is defined by at least a regular expression, context free grammar or computable function, wherein the pattern is operatively configured with a middle text, where the middle text is between desired topics of information and the various makes and models of a transportation vehicle.

3. The method of claim 1, wherein the pattern includes a prefix text and suffix text, wherein the prefix text precedes desired transportation topics and generates information and the suffix text follows desired transportation topics of information and enables communication of the found topics of information including an order of the transportation topics of information for each make and modeled vehicle, and at least a transportation company rendering service to a terrorist.

4. The method of claim 1, wherein the pattern includes a URL prefix, where the URL prefix is the initial portion of the URL where the pattern was identified in relation to responding to the said transportation topics of information, and further comprising verifying if an additional topic of information that matches a predetermined number of patterns, wherein the predetermined number of patterns is greater than at least 1, and wherein the additional transportation topic of information is rejected if it does not match at least once, and the predetermined number of patterns is greater than at least 1.

5. The method of claim 1, further comprising verifying if the pattern has at least specificity less than a predetermined specificity, wherein the pattern is rejected if the specificity is less than the predetermined specificity of at least a make and modeled vehicle, at least a terrorist and/or their network, and whereby repeating the searching, analyzing and extracting for additional transportation topics of information is enabled, wherein the searching, analyzing and extracting for the additional topics of information continues until no more patterns are identified that have a specificity greater than the predetermined specificity.

6. The method of claim 5, wherein the database is the World Wide Web and the specificity increases in proportion to the number of topics of information that match the pattern, wherein calculating the specificity is enabled by multiplying text string lengths of components of the pattern.

7. The method of claim 1, wherein the centralized transportation search engine comprises computer program product for extracting transportation topics of information from a database, further comprising the steps of:
enabling a computer code that searches the database for occurrences of at least one topic of information;
enabling a computer code that analyzes an occurrence of a topic of information that was found in the database to identify a pattern in which the topic of information was stored;
enabling a computer code that extracts additional topics of information from the database utilizing the pattern;
communicating with a computer readable medium that stores the computer codes.
Implementing at least a method of extracting information from a database;
searching the database for occurrences of topics of information;
analyzing the occurrences of the transportation topics of information that were found in the database to identify a pattern in which the topics of information were stored, wherein a pattern includes a prefix text, a middle text and suffix text, where the prefix text precedes desired information in the topics of information, the middle text is between desired information in the topics of information and the suffix text follows desired information in the topics of information;
extracting additional topics of information from the database utilizing the pattern; and
repeating the searching, analyzing and extracting for additional transportation topics of information.

8. The method of claim 7, wherein repeating of the searching, analyzing and extracting for the additional topics of information continues until a predetermined number of topics of information are extracted and further comprising providing the topics of information as examples of information that are desired, and wherein the centralized transportation search engine operatively configured with at least a computer readable medium, including at least a CD-ROM, floppy disk, tape, flash memory, system memory, hard drive, or data signal embodied in a carrier wave.

9. The method of claim 7, wherein the pattern includes an order of the information in the transportation topics of information, and further includes a URL prefix, where the URL prefix is the initial portion of the URL where the pattern was identified, and wherein the centralized transportation search engine includes means for verifying if an additional topic of information matches a predetermined number of patterns, wherein the predetermined number of patterns is greater than 1.

10. The method of claim 9, further comprising verifying if the pattern has a specificity less than a predetermined specificity and further comprising repeating the searching, analyzing and extracting for additional topics of information, wherein the searching, analyzing and extracting for the additional topics of information continues until no more patterns are identified that have a specificity greater than the predetermined specificity, wherein the additional topic is rejected if it does not match at least the predetermined number of patterns and the pattern is rejected if the specificity is less than the predetermined specificity.

11. A centralized Transportation search engine for routing and extracting transportation topics of information from a database such as the web and enabling computer implemented method of extracting the said transportation information to enable transportation data sharing, parts purchasing, preventive maintenance scheduling and services, and enabling solutions to failed transportation components through the web, forming a centralized transportation communication vehicle that enables communication with different systems and responsive to all different platforms, enabling the platforms to talk to one another through one centralized system that integrates with all government transportation agencies, all police stations, all fire department agencies, and all local government agencies seamlessly in real time, and wherein the centralized transportation vehicle forming a broadband for a centralized transportation communication system having the capabilities to integrate seamlessly with all existing transportation industries, commercial transportation companies, all fleet and STEMS, all car rental companies, and all garages in the nation and around the world through their local existing systems and enabling these systems to talk to each other and communicate better in real time interaction, real responsive, real resourceful, and real responsible to transportation system analysis, preventive maintenance scheduling and reprogramming, terrorist name search through a centralized database, wherein the centralized system interaction with existing companies comprising the steps of:
Using a centralized system to communicate with transportation companies, corporations, car rental companies, garages, and industries seamlessly via a network communicatively connected to at least a server operatively configured with software programs for identifying stored information accessible over said network;
receiving initial results of an initial search by the network client of the stored information from a network server;
performing an additional search of the initial results from the network on the results received, wherein the additional search provides additional results;
transferring data associated with the additional results from the network client back to the network server;
identifying stored information comprises identifying information accessible using the Internet;
receiving initial results comprises receiving descriptions of transportation topics of information and files accessible over the network;
receiving topics descriptions comprises receiving network addresses associated with the transportation topics and files.
performing an additional search comprises comparing the initial results to user-entered criteria and downloading the files corresponding to the initial results, and comparing the downloaded files to user-entered criteria.
performing an additional search comprises categorizing files referenced by the initial results and categorizing comprises manipulating icons within a graphical user interface executable on the network;
transferring data associated with the additional results comprises transferring a categorization of the initial results and transferring data associated with the additional results comprises transferring an indicator of the relevance of at least one of the files; and
transferring data comprises transferring the additional results and comprises transferring instructions for updating a database, and said instructions are derived from said additional results.

12. A method of claim 11, further comprising using a network server in identifying stored information accessible over a network,
transferring to a network client initial results of an initial search of the stored transportation information;
receiving from the network client data associated with additional results from an additional search of the initial results transferred to and located on the network client;
using the received data to update a database on the network server containing transportation topics of information characterizing the stored information, such that results of future searches may be improved;
selecting a preferred product from a list that includes a plurality of products for at least a transportation topic;
presenting a sequence of queries on transportation topics to a user, the user responding to each query in sequence with a corresponding response;
in response to a user response to a query in the sequence, using a neural network to delete at least one product from the list to provide an updated list;
continuing with the presentation of the sequence of queries to the user in the event that the user does not select a preferred product from the updated list; and
selecting at least a product from a group consisting of centralized transportation parts shopping or ware house services, preventive maintenance services, terrorist name search, Standard Transportation Excellent Maintenance Solution and services, transportation content, and credit card processing services, insurance services, telecommunications services, and combinations thereof.

13. The method of claim 12, wherein the queries are presented to the user via at least a network based browser operatively configured with the centralized transportation search engine server having means for generating an updated list of products and information from an original list of a plurality of products and information, and communicatively connected to a neural network-based transportation decision engine for responding to user sequence of queries provided, upon receipt of a query, enabling responses and deleting at least one product from a current list of products to provide the updated list of products is enabled.

14. The method of claim 13, wherein the services include centralized transportation parts shopping or ware house services via a network or an internet network, intranet/ network, and further includes tracking down terrorist by name and by at least a transportation topic of activity.

15. A Centralized transportation search server engine operatively configured with a neural network based transportation decision engine communicatively connected to at least a computer means for generating a sequence of plurality of queries and for selecting at least a preferred product as a function of responses to the queries, wherein a transportation decision engine generates subsequent queries as a function of at least a response to a previous query and wherein the transportation decision engine selects the preferred product and services as a function of a number of responses that are less than or equal to the plurality of queries, said centralized Transportation search engine routing and extracting transportation topics of information from a database such as the web and enabling computer implemented method of extracting the said transportation information to enable transportation data sharing, parts purchasing, preventive maintenance and services, and solution to failed components through the web, forming a centralized transportation communication vehicle that enables communication with different systems and responsive to all different platforms and enabling the platforms to talk to one another through one central system that integrates with all government transportation agencies, all police stations, all fire department agencies, and all local government agencies seamlessly in real time, and wherein the centralized transportation vehicle forming a broadband for a centralized transportation communication system having the capabilities to integrate seamlessly with all existing transportation industries, commercial transportation companies, all fleet and STEMS, and all garages in the nation and around the world through their local existing systems and enabling these systems to talk to each other and communicate better in real time interaction, real responsive, real resourceful, and real responsible to transportation system analysis, preventive maintenance scheduling and reprogramming, wherein the centralized database interaction with existing companies the search engine server comprising:
a cache engine responsive for identifying downloadable content of transportation topics of information;
a database operatively connected to the transportation decision engine, wherein the database stores the queries and query correlation;
transportation decision engine for calculating a confidence level after receiving a response, wherein the transportation decision engine selects a preferred product as a function of the responses received before the confidence level exceeds a confidence threshold;
means for determining a confidence level after receiving each response to at least a query, wherein the query includes a centralized transportation parts shopping or ware house type query that classifies a user by the user's centralized transportation parts shopping or ware house preferences;
a neural network based transportation decision engine that automatically generates queries and selects a preferred product as a function of responses to the queries, wherein the transportation decision engine generates first and second queries, where the second query is a function of a response to the first query, and wherein the transportation decision engine comprises a plurality of self organizing maps comprising a plurality of memory locations for storing sub words, wherein the memory locations comprises a corresponding link, wherein the transportation decision engine compares a response to a subset of the sub words.
means for proving at least one topic of information as an example of information for a terrorist name in a local existing system;
means for repeating the searching, analyzing and extracting data for additional topics of information that is desired for tracking a terrorist desiring a transportation service.
a training module for training the transportation decision engine, wherein the training module allows iterative training of the transportation decision engine; and
means for generating the queries using stochastic modulation.

16. The centralized transportation search engine server of claim 15, further comprising:
a retraining module that adjusts links between memory locations as a function of a response;
means responsive to a query relating to the accuracy of the neural network in selecting the preferred topic and/or product;
a retraining module that adjusts a correlation as a function of said response;
said retraining module adjusting a correlation as a function of an activity with the preferred topic and/or product;
said retraining module adjusting a correlation as a function of vendor input;
said vendor is a vendor of Standard Transportation Excellent Maintenance Solution and services, including car rental services; and
said vendor is a vendor of transportation services and topics, including a centralized transportation parts and/or ware house services.

17. The centralized transportation search engine server of claim 16, wherein said means responsive for identifying stored information accessible over a network communicatively connected with a network client responsible for performing an additional search on initial search results received from a network server, wherein the network client further responsive for transferring data associated with additional search results to the network server.

18. The centralized transportation search engine server of claim 16, wherein a client-side search program responsive for comparing the initial search results to user-entered criteria is operatively configured with the network client, said network client comprises a computational device, including at least a processor, a storage device, a browser program, and a client-side search program, and wherein the computational device comprises a computer, telephone or personal digital assistant, said client-side search program comparing network-accessible files referenced within the initial search results to user-entered criteria, further comprising:
the client-side search program configured with categorized network-accessible files referenced within the initial search results;
means for identifying stored information accessible over a network, said means comprising at least a network server operatively configured with a network client for transferring initial search results said network client and receive from the network client data associated with additional search results from an additional search of the initial search results; and
said network server further comprises a database including information characterizing network-accessible files, and wherein said network server is further operatively configured with at least a system having means to use the data received from the network server and communicatively connected to said network client for updating the database for enabling improvement on the results of future searches.

19. A centralized transportation search engine operatively configured with at least a computer-usable carrier medium, said centralized transportation search engine routing and extracting transportation topics of information from a database such as the web and enabling computer implemented method of extracting the said transportation information to enable transportation data sharing, parts purchasing, preventive maintenance and services, terrorist tracking through transportation topics of services and enabling routing at least a solution to failed components through the web, forming a centralized transportation communication vehicle that enables communication with different systems and responsive to all different platforms and enabling the platforms to talk to one another through one central system that integrates with all government transportation agencies, all police stations, all fire department agencies, and all local government agencies seamlessly in real time, and wherein the centralized transportation vehicle forming a broadband for a centralized transportation communication system having the capabilities to integrate seamlessly with all existing transportation industries, commercial transportation companies, all fleet and STEMS, and all garages in the nation and around the world through their local existing systems and enabling these systems to talk to each other and communicate better in real time interaction, real responsive, real resourceful, and real responsible to transportation system analysis, preventive maintenance scheduling and reprogramming, wherein the centralized database interaction with existing companies, comprising:
first program instructions executable on a computational device of a network client for receiving from a network server initial results of an initial search of stored information available over a network linking the computational device and the network server;
second program instructions executable on the computational device of the network client for performing an additional search of the initial results, wherein the additional search provides additional results; and
third program instructions executable on the computational device of the network client for transferring data associated with the additional results to the network server.
said first program instructions further configured to receive said initial results from at least a server-side search program executable on at least a network server.
Said first program instructions executable on a computational device of a network server for transferring to a network client initial results of an initial search of stored information available over a network linking the computational device and the network client; and
second program instructions executable on the computational device of the network server for receiving data associated with additional search results from the network client.
said carrier medium further comprising said third program instructions executable on the computational device for using the data received from the network client to update a database used in performing the initial search.

20. The method of claim 1, further comprising:
automatically selecting a preferred name or product from a list of terrorist and/or products;
generating a plurality of queries;
automatically selecting a preferred product from the list of products and a name from the list of terrorist using a neural network configured with a transportation decision engine to analyze responses to the queries;
wherein the transportation decision engine automatically generates first and second queries, where the second query is a function of a response to the first query;
and wherein the transportation decision engine selects the preferred product is a function of fewer responses than the plurality of queries;
wherein the network is an internet network;
wherein the network is an intranet network;

21. The method of claim 20, wherein the step of generating transportation topic queries comprises generating queries using stochastic modulation;
generating a retraining query and retraining the neural network as a function of a response to the retraining query;
generating a query with a set of response options, where the response options are a function of trend data;
wherein the trend data includes stock-related trend data.

22. The method of claim 21, wherein the trend data includes at least a centralized transportation parts shopping or ware house-related trend data, and further comprises market trend data, user trend data, comprising the step of:
selecting a preferred product as a function of a user profile that includes information submitted during a current user session.
relating information to responses from a user's prior selection process and prior activities with a vendor.

23. The method of claim 4, further comprising:
generating a transportation topics of information as a function of at least a query and/or responses, wherein the generating queries includes generating queries until the confidence level exceeds a confidence threshold.
retraining the neural network.
wherein the retraining the neural network comprises retraining the neural network as a function of the responses.
retraining the neural network further comprises retraining the neural network as a function of response trends.
retraining the neural network further comprises retraining the neural network as a function of market trends.
